(19) United States
(12) Patent Application Publication
(10) Pub. No.: US 2026/0222548 A1
(43) Pub. Date: Jul. 30, 2026

(54) DECODING METHOD, ENCODING METHOD, DECODER, AND COMPUTER-READABLE STORAGE MEDIUM

(71) Applicant: GUANGDONG OPPO MOBILE TELECOMMUNICATIONS CORP., LTD., Dongguan (CN)

(72) Inventors: Yue YU, Dongguan (CN); Haoping YU, Dongguan (CN); Jonathan GAN, Dongguan (CN)

(73) Assignee: GUANGDONG OPPO MOBILE TELECOMMUNICATIONS CORP., LTD., Dongguan (CN)

(21) Appl. No.: 19/575,146

(22) Filed: Mar. 23, 2026

Related U.S. Application Data
(63) Continuation of application No. PCT/CN2024/122004, filed on Sep. 27, 2024.
(60) Provisional application No. 63/541,716, filed on Sep. 29, 2023.

(51) Int. Cl. H04N 19/105; H04N 19/159; H04N 19/176; H04N 19/82

(52) U.S. Cl. CPC H04N 19/105; H04N 19/159; H04N 19/176; H04N 19/82

(57) ABSTRACT

A method of decoding includes that: obtaining, by a processor, a plurality of reference blocks; and in response to determining a filtered inter (FInter) prediction mode is selected for a current block, generating, by the processor, an FInter prediction of the current block based on the plurality of reference blocks. A method for encoding, a decoder, and a computer-readable storage medium are also provided.

### CROSS-REFERENCE TO RELATED APPLICATIONS

This application is a continuation of International Application No. PCT/CN2024/122004, filed on Sep. 27, 2024, which claims the benefit of and priority to U.S. Provisional Application No. 63/541,716, entitled “FILTERED INTER PREDICTION FOR VIDEO CODING” and filed on Sep. 29, 2023, the contents of these applications are incorporated by reference herein in their entireties.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but are not limited to, versatile video coding (H.266/VVC), high-efficiency video coding (H.265/HEVC), advanced video coding (H.264/AVC), moving picture expert group (MPEG) coding, enhanced video coding model (ECM), to name a few.

### SUMMARY

According to one aspect of the present disclosure, a method of decoding is provided. The method may include obtaining, by a processor, a plurality of reference blocks. The method may include, in response to determining a filtered inter (FInter) prediction mode is selected for a current block, generating, by the processor, an FInter prediction of the current block based on the plurality of reference blocks.

According to another aspect of the present disclosure, a decoder is provided. The decoder may include a processor and memory storing instructions. The memory storing instructions, which when executed by the processor, may cause the processor to obtain a plurality of reference blocks. The memory storing instructions, which when executed by the processor, may cause the processor to, in response to determining an FInter prediction mode is selected for a current block, generate an FInter prediction of the current block based on the plurality of reference blocks.

According to still another aspect of the present disclosure, a method of encoding is provided. The method may include obtaining, by a processor, a plurality of reference blocks. The method may include, in response to determining an FInter prediction mode is selected for a current block, generating, by the processor, an FInter prediction of the current block based on the plurality of reference blocks.

According to still a further aspect of the present disclosure, a non-transitory computer-readable medium storing a bitstream is provided. The bitstream may be generated according to the encoding method disclosed herein.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates an exemplary picture divided into coding tree units (CTUs), according to some embodiments of the present disclosure.

FIG. 6 illustrates an exemplary CTU divided into coding units (CUs), according to some embodiments of the present disclosure.

FIG. 7 illustrates a schematic visualization of a current CU block and spatially adjacent and non-adjacent reconstructed samples to the current block, according to some embodiments of the present disclosure.

FIG. 8 illustrates a schematic visualization of the angular modes of VVC, according to some embodiments of the present disclosure.

FIG. 9A illustrates a representation of spatial geometric partitioning mode (SGPM) signaling, according to some embodiments of the present disclosure.

FIG. 9B illustrates an example template used to generate a candidate list, according to some embodiments of the present disclosure.

FIG. 10 illustrates a schematic visualization of the inter angular mode parallel to the GPM partitioning boundary (Parallel mode) (see (a)), the inter angular mode perpendicular to the GPM partitioning boundary (Perpendicular mode) (see (b)), and the inter prediction Planar mode (see (c)), and SGPM with intra and inter prediction (see (d)), according to some embodiments of the present disclosure.

FIG. 11 illustrates an adaptive SGPM blending scheme, according to some embodiments of the present disclosure.

FIG. 12 illustrates an example visualization of intra block copy (IBC) prediction, according to some embodiments of the present disclosure.

FIG. 13 illustrates a diagram of intra template matching prediction (intraTMP), according to some embodiments of the present disclosure.

FIG. 14 illustrates a decoder-side intra mode derivation (DIMD) mode for ECM, according to some embodiments of the present disclosure.

FIG. 15 illustrates a template-based intra mode derivation (TIMD) mode for ECM, according to some embodiments of the present disclosure.

FIG. 16A illustrates a low-frequency non-separable transform (LFNST) kernel for 4×N and N×4 block sizes in VVC, according to some embodiments of the present disclosure.

FIG. 16B illustrates an LFNST kernel for 8×N and N×8 block sizes in VVC, according to some embodiments of the present disclosure.

FIG. 17 illustrates various intra angular prediction modes, according to some embodiments of the present disclosure.

FIG. 18A illustrates an LFNST kernel for 4×N and N×4 block sizes in ECM, according to some embodiments of the present disclosure.

FIG. 18B illustrates an LFNST kernel for 8×N and N×8 block sizes in ECM, according to some embodiments of the present disclosure.

FIG. 18C illustrates an LFNST kernel 16×16 block size in ECM, according to some embodiments of the present disclosure.

FIG. 19 illustrates an example visualization of an inter prediction mode, according to some aspects of the present disclosure.

FIG. 20 illustrates an example visualization of the spatial support of a learned filter, according to some embodiments of the present disclosure.

FIG. 21 illustrates an example visualization of a reference block/template for FInter prediction, according to some embodiments of the present disclosure.

FIGS. 22A and 22B illustrate a flowchart of an exemplary method of decoding, according to some embodiments of the present disclosure.

FIGS. 23A and 23B illustrate a flowchart of an exemplary method of encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

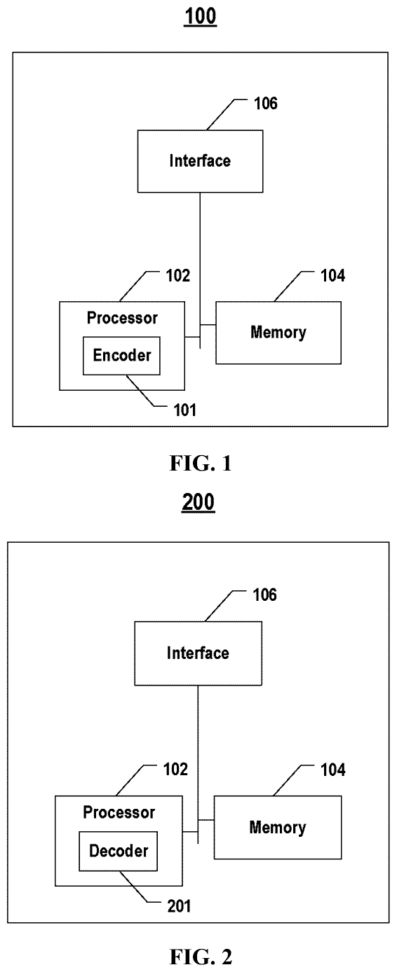

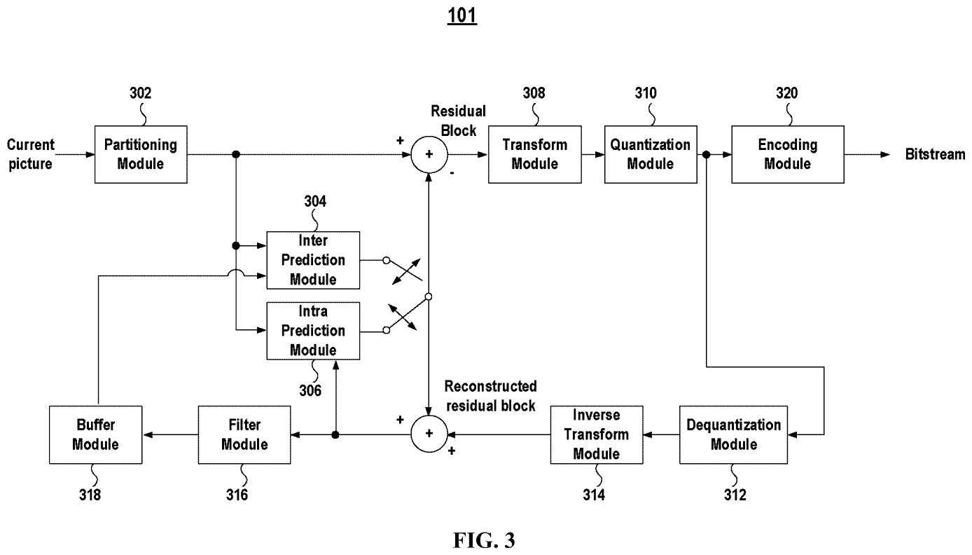

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in the process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated into an application processor (AP) SoC that handles application processing in an operating system (OS) environment, including running video encoding and decoding applications. In another example, processor 102, memory 104, and interface 106 may be integrated into a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail.

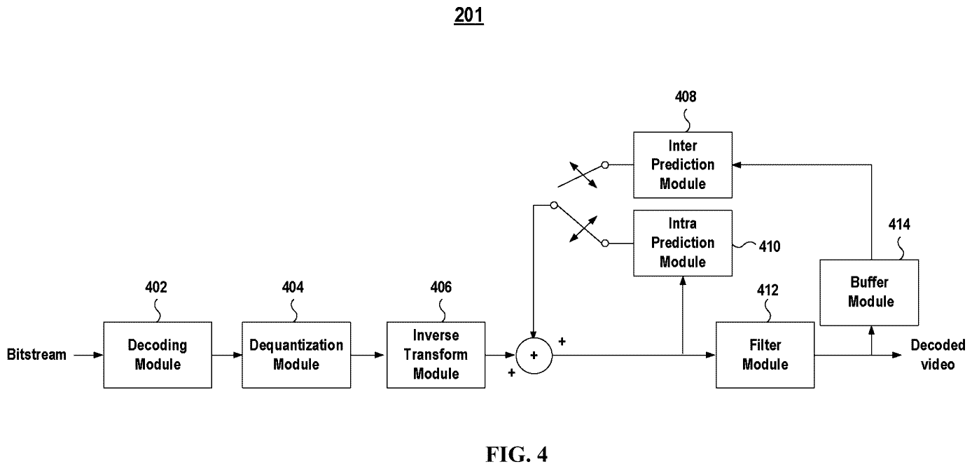

FIG. 3 illustrates a detailed block diagram of exemplary encoder 101 in encoding system 100 in FIG. 1, according to some embodiments of the present disclosure. As shown in FIG. 3, encoder 101 may include a partitioning module 302, an inter prediction module 304, an intra prediction module 306, a transform module 308, a quantization module 310, a dequantization module 312, an inverse transform module 314, a filter module 316, a buffer module 318, and an encoding module 320. It is understood that each of the elements shown in FIG. 3 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101.

Partitioning module 302 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 302 may partition a picture into a combination of a plurality of coding units, prediction units, and transform units, and encode a picture by selecting a combination of a coding unit, a prediction unit, and a transform unit based on a predetermined criterion (e.g., a cost function).

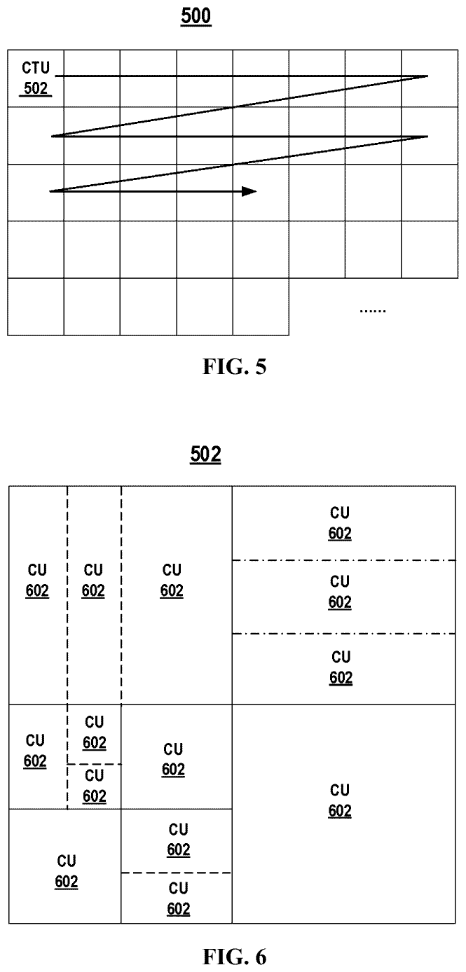

Similar to H.265/HEVC, H.266/VVC is a block-based hybrid spatial and temporal predictive coding scheme. As shown in FIG. 5, during encoding, an input picture 500 is first divided into square blocks-CTUs 502, by partitioning module 302. For example, CTUs 502 can be blocks of 128×128 pixels. As shown in FIG. 6, each CTU 502 in input picture 500 can be partitioned by partitioning module 302 into one or more CUs 602, which can be used for prediction and transformation. Unlike H.265/HEVC, in H.266/VVC, CUs 602 can be rectangular or square, and can be coded without further partitioning into prediction units or transform units. For example, as shown in FIG. 6, the partition of CTU 502 into CUs 602 may include quadtree splitting (indicated in solid lines), binary tree splitting (indicated in dashed lines), and ternary splitting (indicated in dash-dotted lines). Each CU 602 can be as large as its root CTU 502 or be subdivisions of root CTU 502 as small as 4×4 blocks, according to some embodiments.

Referring to FIG. 3, inter prediction module 304 may be configured to perform inter prediction on a prediction unit, and intra prediction module 306 may be configured to perform intra prediction on a prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a prediction unit, and transform may be performed in a transform unit. Residual coefficients in a residual block between the generated prediction block and the original block may be input into transform module 308. In addition, prediction mode information, motion vector information, and the like used for prediction may be encoded by encoding module 320 together with the residual coefficients or quantization levels into the bitstream. It is understood that in certain encoding modes, an original block may be encoded as it is without generating a prediction block through prediction module 304 or 306. It is also understood that in certain encoding modes, prediction, transform, and/or quantization may be skipped as well.

In some embodiments, inter prediction module 304 may predict a prediction unit based on information on at least one picture among pictures before or after the current picture, and in some cases, it may predict a prediction unit based on information on a partial area that has been encoded in the current picture. Inter prediction module 304 may include sub-modules, such as a reference picture interpolation module, a motion prediction module, and a motion compensation module (not shown). For example, the reference picture interpolation module may receive reference picture information from buffer module 318 and generate pixel information of an integer number of pixels from the reference picture. In the case of a luminance pixel, a discrete cosine transform (DCT)-based 8-tap interpolation filter with a varying filter coefficient may be used to generate pixel information of an integer number of pixels by the unit of ¼ pixels. In the case of a color difference signal, a DCT-based 4-tap interpolation filter with a varying filter coefficient may be used to generate pixel information of an integer number of pixels by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 3, in some embodiments, intra prediction module 306 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. If the size of the prediction unit is the same as the size of the transform unit when intra prediction is performed, the intra prediction may be performed for the prediction unit based on pixels on the left side, pixels on the top-left side, and pixels on the top of the prediction unit. However, if the size of the prediction unit is different from the size of the transform unit when the intra prediction is performed, the intra prediction may be performed using a reference pixel based on the transform unit.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit are the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 3, a residual module including a prediction module that has performed prediction based on the prediction module generated by prediction module 304 or 306 and residual coefficient information (also referred to herein as the “residual”), which is a difference value of the prediction unit with the original block, may be generated. The generated residual block may be input into transform module 308. Additional details of residuals and transforms for video coding will now be provided.

In hybrid video coding systems, redundancy in the video signal is first exploited by applying inter or intra prediction tools for each CU. The difference between the original samples of a CU and the prediction block for that CU is commonly referred to as the residual. Even after prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

For example, transform module 308 may transform the residual using an integerized version of the two-dimensional discrete cosine transform (DCT), which may be applied separably in the horizontal and vertical directions. For an M×N block of residual samples (where M is the width of the block and N is the height of the block), transform module 308 may obtain transform coefficients by applying an M×M DCT to each row, resulting in intermediate transform coefficients, and then applying an N×N DCT to each column of intermediate transform coefficients.

For intra-coded CUs (also referred to herein as “intra CUs”), spatial neighboring reconstructed samples are used to predict the current block, and the intra prediction mode is signaled once for the entire CU. Each CU consists of one or more collocated coding blocks (CBs) corresponding to the color components of the video sequence. For example, consumer video typically takes the 4:2:0 chroma format, in which case each CU consists of a luma CB and two chroma CBs with one-quarter the samples of the luma CB. Intra prediction and transform coding are performed at the prediction block (PB) and transform block (TB) level, respectively. Each CB consists of a single TB, except in the cases of Intra Subpartition (ISP) mode and implicit splitting. For luma CBs, the maximum side length of a TB is 64, and the minimum side length is 4. In addition, luma TBs are further specified as W×H rectangular blocks of width W and height H, where W, H∈{4, 8, 16, 32, 64}. For chroma CBs, the maximum TB side length is 32, and chroma TBs are rectangular W×H blocks of width W and height H. Here, W, H∈{2, 4, 8, 16, 32}, but blocks of shapes 2×H and 4×2 are excluded in order to address memory architecture and throughput requirements.

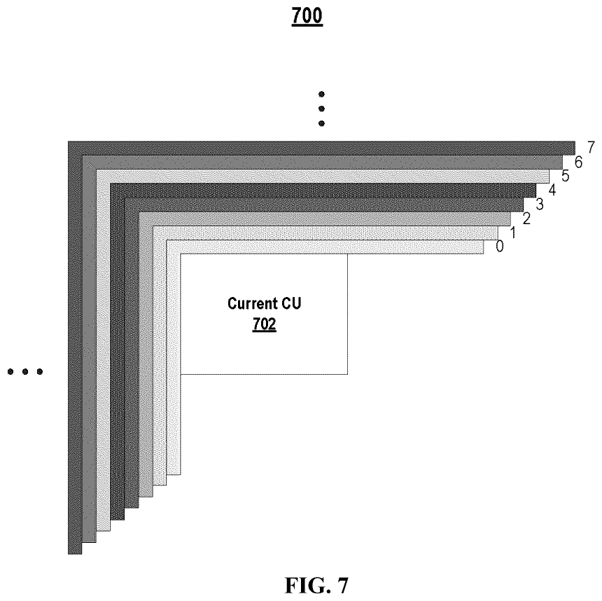

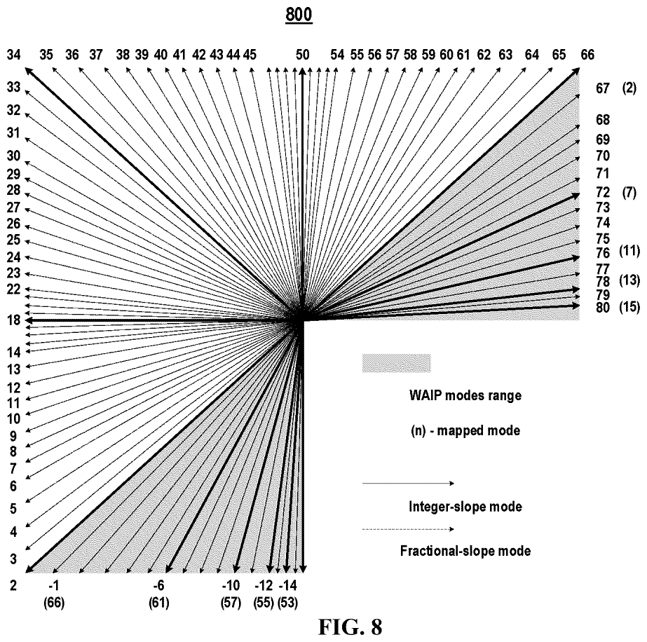

FIG. 7 illustrates a schematic visualization 700 of a current CU block 702 and spatially adjacent and non-adjacent reconstructed samples to the current block, according to some aspects of the present disclosure. In FIG. 7, the number 0, 1, 2, . . . indicates the pixel-line index in relation to current CU block 702.

In VVC, the intra prediction samples for the current block are generated using reference samples that are obtained from reconstructed samples of neighboring blocks. For a W×H block, the reference samples are spatially adjacent to the current block, consisting of the vertical line of 2·H reconstructed samples to the left of the block and extending downwards, the top left reconstructed sample, and the horizontal line of 2·W reconstructed samples above the current block and extending to the right. This “L” shaped set of samples may be referred to in this disclosure as a “reference line”. The reference line directly adjacent to current CU block 702 is shown as the line with index 0 in FIG. 7.

Similar to AVC and HEVC, VVC also supports angular intra prediction modes. Angular intra prediction is a directional intra prediction method. In comparison to HEVC, the angular intra prediction of VVC was modified by increasing the prediction accuracy and by an adaptation to the new partitioning framework. The former was realized by enlarging the number of angular prediction directions and by more accurate interpolation filters, while the latter was achieved by introducing wide-angular intra prediction modes. In VVC, the number of directional modes available for a given block is increased to 65 directions from the 33 HEVC directions. The angular modes 800 of VVC are depicted in FIG. 8.

The directions having even indices between 2 and 66 are equivalent to the directions of the angular modes supported in HEVC. For blocks of square shape, an equal number of angular modes is assigned to the top and left side of a block. On the other hand, intra blocks of rectangular shape, which are not present in HEVC, are a central part of VVC's partitioning scheme with additional intra prediction directions assigned to the longer side of a block. The additional modes allocated along a longer side are called Wide-Angle Intra Prediction (WAIP) modes, since they correspond to prediction directions with angles greater than 45° relative to the horizontal or vertical mode. A WAIP mode for a given mode index is defined by mapping the original directional mode to a mode that has the opposite direction with an index offset equal to one, as shown in FIG. 8. For a given rectangular block, the aspect ratio, i.e., the ratio of width to height, is used to determine which angular modes are to be replaced by the corresponding wide-angular modes.

For square-shaped blocks in VVC, each pair of predicted samples that are horizontally or vertically adjacent is predicted from a pair of adjacent reference samples. To the contrary, WAIP extends the angular range of directional prediction beyond 45°, and therefore, for a coding block predicted with a WAIP mode, adjacent predicted samples may be predicted from non-adjacent reference samples.

In addition to the directly adjacent line of neighboring samples, one of the two non-adjacent reference lines (line 1 and line 2) that are depicted in FIG. 7 may include the input samples for intra prediction in VVC. For ECM, more non-adjacent reference lines may be used. The use of adjacent and non-adjacent reference samples is referred to as multiple reference line (MRL) prediction.

The intra modes that can be used for MRL are the DC mode and the angular prediction modes. However, for a given block, not all of these modes can be combined with MRL. The MRL mode is always coupled with a mode in the Most Probable Mode (MPM) list in VVC. This coupling means that if non-adjacent reference lines are used, the intra prediction mode is one of the MPMs. Such a design of an MPM-based MRL prediction mode is motivated by the observation that non-adjacent reference lines are mainly beneficial for texture patterns with sharp and strongly directed edges. In these cases, MPMs are much more frequently selected since there is typically a strong correlation between the texture patterns of the neighboring and the current blocks. On the other hand, choosing a non-MPM for intra prediction is an indication that edges are not consistently distributed in neighboring blocks, and thus, the MRL prediction mode is expected to be less useful in this case. In addition, it has been observed that MRL does not provide additional coding gain when the intra prediction mode is the Planar mode, since this mode is typically used for smooth areas. Consequently, MRL excludes the Planar mode, which is always one of the MPMs. The angular or DC prediction process in MRL is very similar to the case of a directly adjacent reference line. However, for angular modes with a non-integer slope, a DCT-based interpolation filter (DCTIF) is always used. This design choice is both evidenced by experimental results and aligned with the empirical observation that MRL is mostly beneficial for sharp and strongly directed edges where the DCTIF is more appropriate since it retains more high frequencies than some other filters.

From a hardware design perspective, applying multiple reference lines as proposed in the initial methods requires extra cost of line buffers that are used for holding the additional reference lines. In typical hardware designs, line buffers are part of the on-chip memory architecture for image and video coding, and it is of great importance to minimize their on-chip area. To address this issue, MRL is disabled and not signaled for the coding units that are attached to the top boundary of the CTU. In this way, the extra buffers for holding non-adjacent reference lines are bounded by 128, which is the width of the largest unit size.

In some known approaches, an intra prediction fusion method was proposed to improve the accuracy of intra prediction. More specifically, if the current block is a luma block, and it is coded with a non-integer slope angular mode and not in the ISP mode, and the block size (width*height) is greater than 16, two prediction blocks generated from two different reference lines will be “fused”, where the prediction fusion is calculated as a weighted summation of the two prediction blocks. More specifically, a first reference line at index i (lineᵢ) is specified with the current methods of signaling in the bitstream, and the prediction block generated from this reference line using the selected intra prediction mode is denoted as p(lineᵢ), where p(⋅) represents the operation of generating a prediction block from a reference line with a given intra prediction mode. In the known approach, the reference line lineᵢ₊₁ is implicitly selected as the second reference line. That is, the second reference line is one index position further away from the current block relative to the first reference line. Similarly, the prediction block generated from the second reference line is denoted as p(lineᵢ₊₁). The weighted sum of the two prediction blocks is obtained as follows and serves as the predictor for the current block according to equation (1).

$${p}_{fusion} = {w}_{0} * p ( {line}_{i} ) + {w}_{1} * p ( {line}_{i + 1} ) , \qquad ( 1 )$$

where p_{fusion} represents the fused prediction, w₀ and w₁ are two weighting factors, and they are set as ¾ and ¼ in the experiment, respectively.

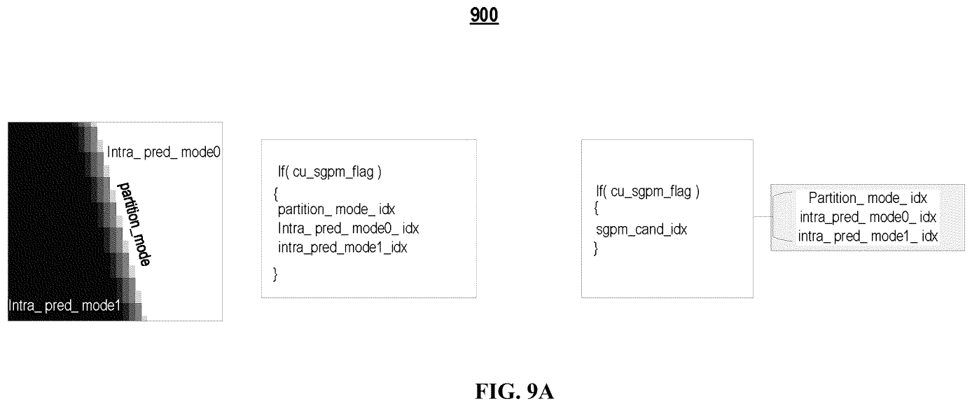

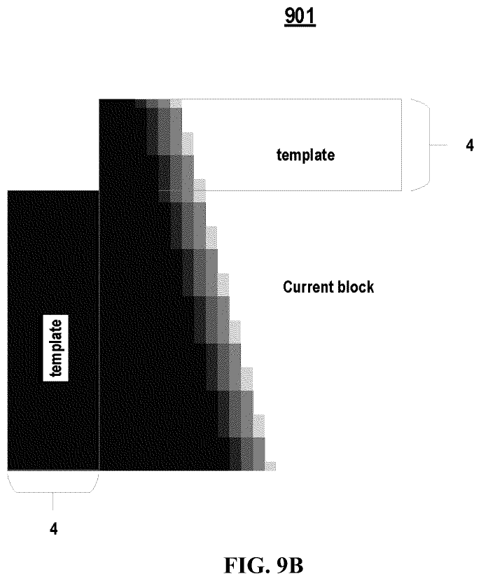

In some known approaches, a spatial geometric partitioning mode (SGPM) was proposed, which allows the partitioning of a CU into two parts that may use different intra prediction modes. The new mode is similar in concept to the geometric partitioning mode (GPM), which applies to inter prediction in VVC. However, SGPM uses a different signalling mechanism due to the large number of combinations of partitions and intra prediction modes that are possible. To express the necessary partition and prediction information more efficiently in the bit-stream, a candidate list is employed and only the candidate index is signaled in the bit-stream. Each candidate in the list can derive a combination of one partition mode and two intra prediction modes, as shown in the representation of SGPM signaling 900 in FIG. 9A.

A template is used to generate this candidate list. One example of the template 901 is shown in FIG. 9B, where the width of the template is set to 4. In the current version of SGPM adopted to ECM, the template width is set to 1. For each possible combination of one partition mode and two intra prediction modes, a prediction is generated for the template with the partitioning weight extended to the template. These combinations are ranked in ascending order of their sum of absolute transformed difference (SATD) costs between the prediction and reconstruction of the template. The length of the candidate list is set equal to 16, and these candidates are regarded as the most probable SGPM combinations of the current block. Both the encoder and decoder construct the same candidate list using the template. To reduce the complexity of building the candidate list, both the number of possible partition modes and the number of possible intra prediction modes (IPM) are limited. For example, the number of possible partition modes in the current version of SGPM adopted for ECM is restricted to a pre-defined set of 26 partitions, which cover a variety of partition directions and locations.

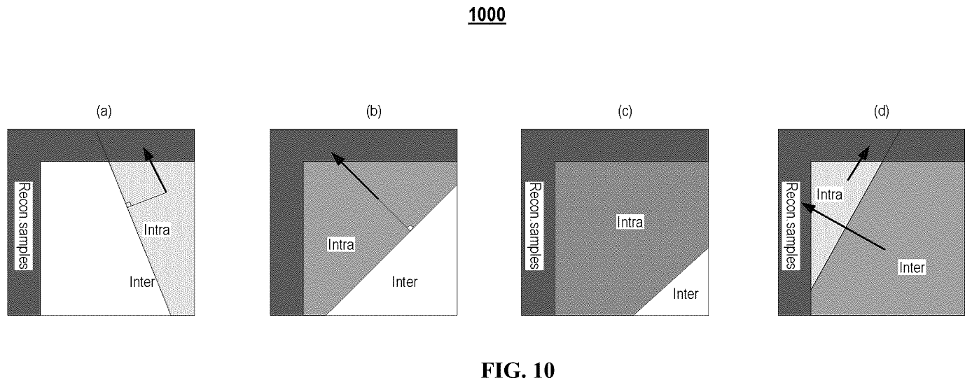

Two IPM candidate lists corresponding to the two SGPM partitions are each constructed by adding available IPM candidates and then pruning, if needed, down to a pre-defined limit of three candidates. Some IPM candidates are inherited from an intra-inter GPM mode already adopted into ECM. FIG. 10 is a schematic visualization 1000 of the inter angular mode parallel to the GPM partitioning boundary (Parallel mode) (see (a)), the inter angular mode perpendicular to the GPM partitioning boundary (Perpendicular mode) (see (b)), and the inter prediction Planar mode (see (c)), and SGPM with intra and intra prediction (see (d)), according to some embodiments of the present disclosure. These modes may be added as available IPM candidates for SGPM.

In addition, template-based intra mode derivation (TIMD) may be used to derive intra prediction modes that are available IPM candidates for SGPM. For example, only neighbors of horizontal and vertical orientations (using the top or left templates) are used to derive TIMD intra prediction modes for forming the IPM of SGPM.

SGPM may be implicitly disabled for some CU block sizes. The range of block sizes for which SGPM may be used (e.g., a CU level flag may be signalled to indicate if SGPM is used or not) was originally inherited from the intra-inter GPM mode. In the current version of SGPM adopted to ECM, the range of block sizes is further extended to smaller blocks of 4×8, 8×4, 4×16, and 16×4 dimensions. In summary, the block sizes for which SGPM may be used may be described by the rule 4<=width<=64, 4<=height<=64, width<height*8, height<width*8, width*height>=32.

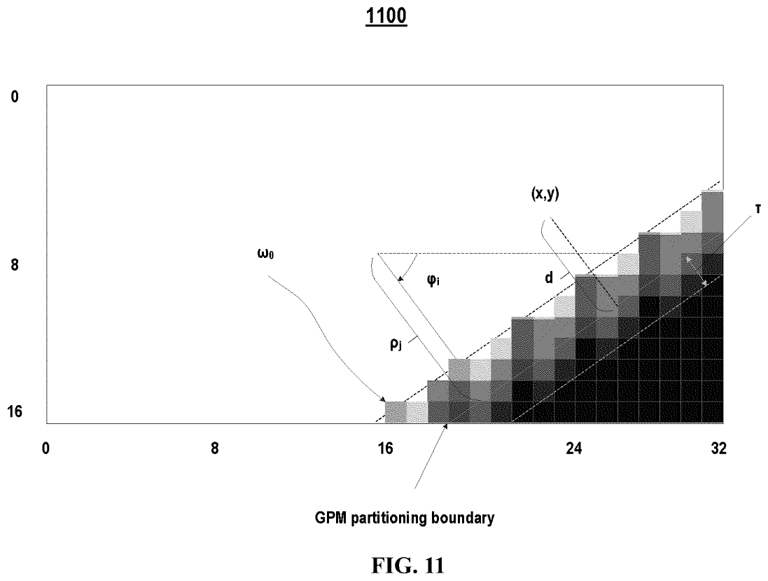

In order to have a better prediction for those pixels that sit in the boundary between two prediction parts, an adaptive SGPM blending scheme 1100 may be used, as shown in FIG. 11, where a weighted average of the two prediction parts is used in a transition region around the SGPM partition. The width of the transition region is referred to as the blending width, and this blending width is adaptively determined depending on the block size. No signalling is needed for adaptive blending.

Referring to FIG. 11, let the blending width as specified for the GPM tool in VVC and ECM be t. Then, the adaptive SGPM blending width may be determined depending on the CU block width and height as follows:
If min (width, height)=4, ½ τ is selected;
else if min (width, height)=8, τ is selected;
else if min (width, height)=16, 2 τ is selected;
else if min (width, height)=32, 4 τ is selected; and
else, 8 τ is selected.

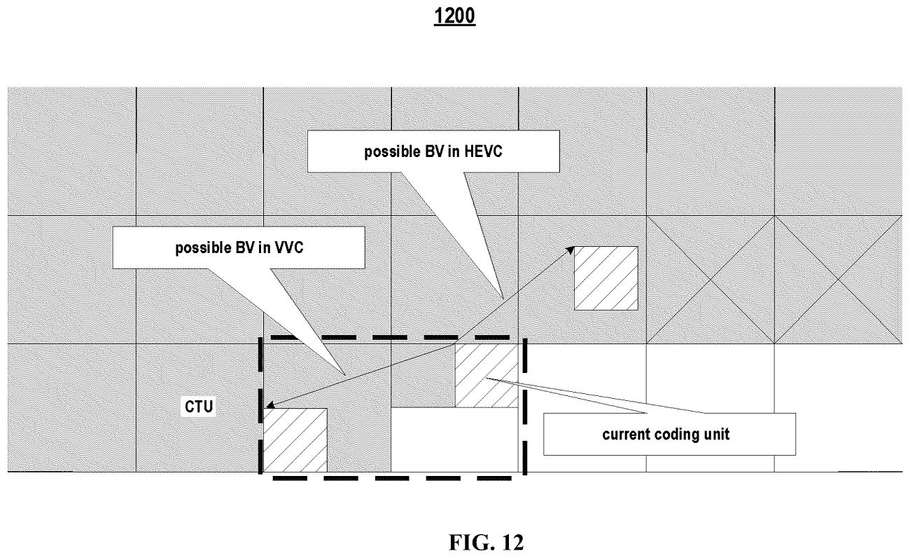

FIG. 12 illustrates an example visualization of IBC prediction 1200, according to some embodiments of the present disclosure. When a CU is predicted by intra block copy mode, a block vector (BV) is signalled to indicate which block within the same picture will be copied to serve as a predictor for the current block. Signalling of this block vector may be performed by signalling a block vector difference (BVD) in the bitstream, such that the block vector can be determined by adding the BVD to a block vector predictor. Alternatively, if a block vector from a previous CU is an exact match for the current block vector, it may be signalled by a merge flag. Regardless of the signalling mechanism, the block vector points at a location within the same picture to indicate a block of samples equal in size to the current CU that is used as a predictor block for the current CU. Some restrictions may apply to the block vector, as it must point at a location in the current picture that has been decoded before the current CU. The illustration in FIG. 12 summarizes the IBC concept in HEVC and VVC, with each tiled square shape in the figure representing a coding tree unit (CTU). The gray-shaded area denotes the already-coded region, whereas the white-shaded area denotes the upcoming coding region. IBC in HEVC generally allows a BV to point at any block contained in the gray-shaded region usage. This freedom is partially restricted when a sps_entropy_coding_sync_enabled_flag is signaled in the bitstream, whose purpose is to support the wavefront parallel processing (WPP) feature. In such case, IBC block vectors cannot point at any region within CTUs 2 or more to the right of the current CTU in the CTU row directly above, as shown by the crossed-out CTUs in FIG. 12. IBC in VVC is significantly more restricted, only allowing block vectors to use the CTU to the left of the current CTU as the reference area, denoted by the dotted frame. The current IBC tool in ECM extends the search range relative to VVC.

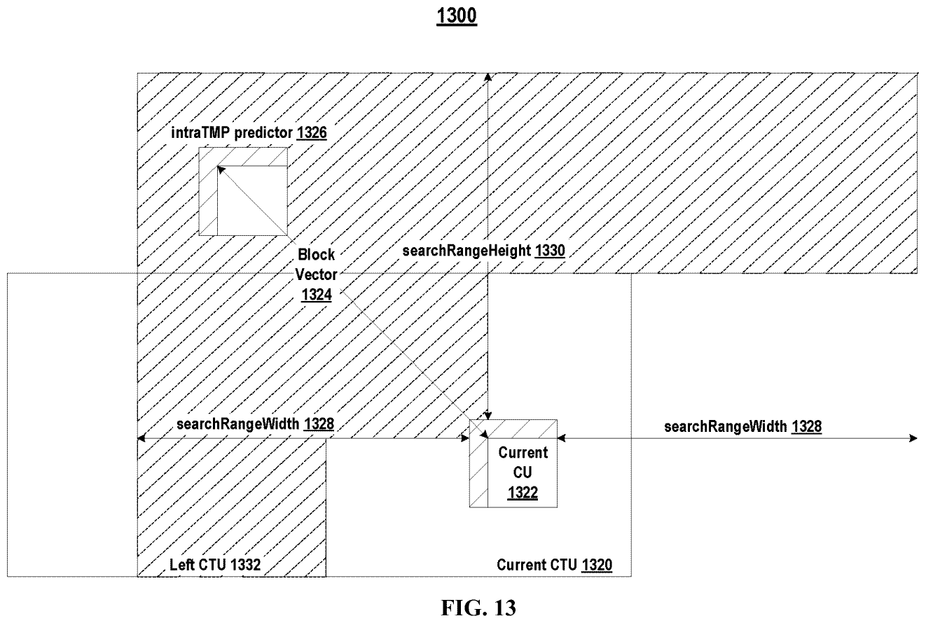

FIG. 13 illustrates a diagram of intraTMP 1300, according to some embodiments of the present disclosure.

Referring to FIG. 13, intraTMP is an intra prediction mode similar to IBC in that the current CU 1322 is also predicted by a block of samples from the current picture. intraTMP may only be selected as a prediction mode for CUs with size 64×64 or smaller. Unlike IBC, however, a block vector 1324 is not signalled in the bitstream in intraTMP. Instead, decoder 201 compares a pre-defined L-shaped or other shaped templates of reconstructed samples neighbouring the current CU 1322 against the same shaped templates of candidate predictors within a pre-determined search region. For the case where the template is L-shaped, both neighbouring samples to the left and above of the current CU 1322 or intraTMP predictor 1326 are used. Let the width of the template area to the left be TmpW, and let the width of the template area above be TmpH. Other template shapes include a left template, which only includes the template area to the left, and an above template, which only consists of the template area above.

The intraTMP predictor block is determined by finding the best candidate template that matches the current CU template. The best match may be determined by finding the template that minimizes the sum of absolute differences (SAD), or the sum of absolute transformed differences (SATD), or by comparing hashes between templates. The search algorithm through the search region may be exhaustive (for example, by scanning the template over the search region with sample-resolution shifts), or fast (for example, by performing a coarse search first, then performing a local refinement search around the best match from the coarse search). Regardless, the search algorithm is performed identically by both the encoder and decoder so that the intraTMP predictor is implicitly known by both encoder 101 and decoder 201 without requiring signalling in the bitstream. An example of intraTMP is shown in FIG. 13 with the current CU template and the best matching template indicated by hatched shading.

Still referring to FIG. 13, for an intraTMP predictor 1326 to be selected, the block of samples corresponding to intraTMP predictor 1326 must be fully contained within the search region. The search region is shown in FIG. 13 by dashed shading. Within the current CTU 1320, the search region is restricted to a rectangular block of samples, bounded at one corner by the top-left corner of the current CTU 1320, and bounded at the other corner by the top-left corner of the current CU 1322.

Outside of the current CTU 1320, the search region is limited by imposing maximum lengths on the intraTMP block vector of (searchRangeWidth 1328, searchRangeHeight 1330), where searchRangeWidth 1328 and searchRangeHeight 1330 are set proportional to the dimensions of the current CU 1322. That is, the searchRangeWidth=a*BlkW and searchRangeHeight=a*BlkH, where ‘a’ is a constant that controls the gain/complexity trade-off, and BlkW and BlkH are the width and height of the current CU 1322, respectively. Here, ‘a’ is set to 5 in the ECM-7.0 test software. searchRangeHeight 1330 only limits the length of the block vectors in the negative vertical direction (that is, in the direction to the top of the picture). For block vectors with a positive vertical component, the search region is limited by the bottom boundary of the current CTU row. For example, in FIG. 13, the search region extends to the bottom boundary of the left CTU 1332, regardless of the value of searchRangeHeight 1330. In addition, these limits to the search range do not apply to the current CTU 1320. For example, for small CUs where searchRangeWidth 1328 and searchRangeHeight 1330 may be small compared to the dimensions of current CTU 1320, the search region still extends as far as the top-left corner of the current CTU 1320.

Beyond the restriction imposed by the search region, the intraTMP predictor 1326 and its template must consist of samples that are available for intra prediction. For example, the boundaries of the search region are still overridden by picture, slice, or tile boundaries. Let the coordinates of the top-left corner of the currentCU relative to the current picture be (currCuX, currCuY). Then, the left boundary of the intraTMP search region is initially intraTmpLeftBound=currCuX−searchRangeWidth. To account for the picture boundary, the left boundary is clipped to allow TmpW sample width for the predictor's template. intraTmpLeftBound=max(intraTmpLeftBound, TmpW)

To speed up the template matching process, the search region is initially traversed horizontally or vertically in increments of 2 pixels at a time. This is also referred to as a search sub-sampling factor of 2. This leads to a 4-fold reduction in the template matching search complexity. After finding the best match from the initial search, a refinement process is performed. The refinement is done via a second template matching search around the best match with a reduced range. In ECM-7.0, the reduced range is set to BlkH/2.

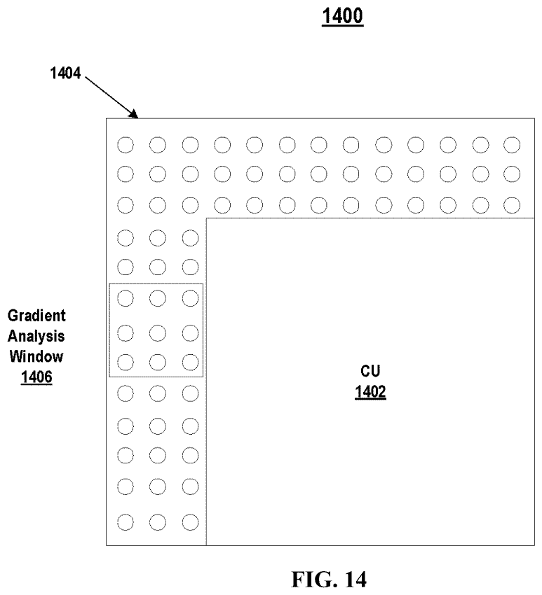

FIG. 14 illustrates a diagram 1400 of a decoder-side intra mode derivation (DIMD) mode for ECM, according to some embodiments of the present disclosure.

Referring to FIG. 14, in DIMD, an intra prediction mode (or multiple intra prediction modes) is derived implicitly from an L-shaped template 1404 (referred to hereinafter as “template 1404”) of reconstructed samples neighbouring the current CU 1402. The template 1404 has a size of a 3-sample width. Decoder 201 moves a 3×3 gradient analyzing window 1406 over the template 1404. At each position, a local gradient is calculated by applying Sobel filters. Assuming the 3×3 set of samples at one position in the template 1404 is Tk, the Sobel filter can be described according to equation (2).

$${M}_{x} = [ \begin{matrix}- 1 & 0 & 1 \\ - 2 & 0 & 2 \\ - 1 & 0 & 1\end{matrix} ] , {M}_{y} = [ \begin{matrix}- 1 & - 2 & - 1 \\ 0 & 0 & 0 \\ 1 & 2 & 1\end{matrix} ] . \qquad ( 2 )$$

Then, the horizontal gradient G_{k,x} and the vertical gradient G_{k,y} are estimated by taking the dot products shown below in equations (3) and (4), respectively.

$${G}_{k , x} = {T}_{k} \cdot {M}_{x} ; and \qquad ( 3 )$$

$${G}_{k , y} = {T}_{k} \cdot {M}_{y} . \qquad ( 4 )$$

The local gradient's magnitude Gₖ and the local gradient's angle θₖ may be estimated according to equations (5) and (6), respectively.

$${G}_{k} = \vert {G}_{k , x} \vert + \vert {G}_{k , y} \vert ; and \qquad ( 5 )$$

$${θ}_{k} = atan ( \frac{{G}_{k , y}}{{G}_{k , x}} ) . \qquad ( 6 )$$

The local gradient's angle θₖ can be associated with an intra angular prediction direction IPMₖ. For example, an angle of 0 degrees corresponds with the horizontal intra prediction mode 18. In practice, IPMₖ may be estimated directly by decoder 201 from G_{k,x} and G_{k,y} with a fast implementation such as a look-up table. At the beginning of the DIMD method, an empty histogram H (populated with zeroes in each entry) is initialized with a size equal to the number of intra prediction modes. As the DIMD method performs gradient analysis over each local window, the histogram H is updated according to equation (7).

$$H [ {IPM}_{k} ] += {G}_{k} . \qquad ( 7 )$$

Thus, each local gradient analysis “votes” for an intra prediction mode. At the conclusion of the DIMD method, the intra prediction mode with the highest count in H may be selected as the single representative intra prediction mode for the current CU. Alternatively, multiple intra prediction modes may also be obtained from H in order of the highest counts.

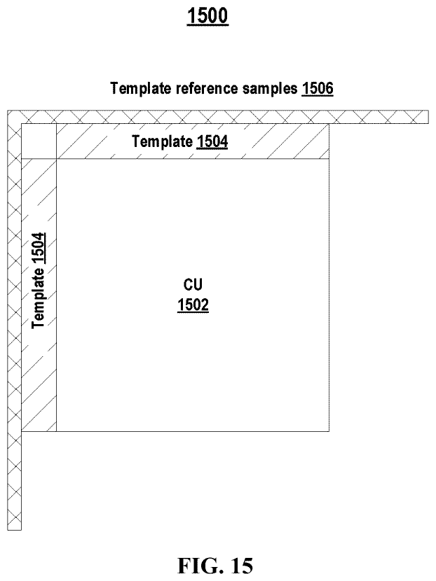

FIG. 15 illustrates a diagram 1500 of a template-based intra mode derivation (TIMD) mode for ECM, according to some embodiments of the present disclosure. Referring to FIG. 15, in TIMD, an intra prediction mode (or multiple intra prediction modes) is derived implicitly from above and left templates 1504 of reconstructed samples neighbouring the current CU 1502.

A set of candidate intra prediction modes is searched from a most probable modes (MPM) list, which is constructed from intra prediction modes used by neighbouring CUs. Then, for each candidate intra prediction mode, a prediction for template 1504 is produced from the template reference samples 1506 by the intra angular prediction method. The candidate intra prediction mode, which produces a template predictor that best matches template 1504 is selected as the TIMD intra prediction mode. The best match may be determined by finding the predictor that minimizes the sum of absolute differences (SAD), or the sum of absolute transformed differences (SATD), or by comparing hashes between the predictor and the template. Alternatively, multiple intra prediction modes may also be obtained in order of increasing SAD/SATD.

The matrix weighted intra prediction (MIP), IBC, and IntraTMP methods can be effective intra prediction modes in ECM. Greater gain may be achieved by enabling combinations of MIP with non-separable primary transform (NSPT), IBC with LFNST and NSPT, and IntraTMP with LFNST and NSPT, with intra prediction mode derived as described in the solutions below in connection with FIG. 4.

Transform module 308 can transform the video signals in the residual block from the pixel domain to a transform domain (e.g., a frequency domain depending on the transform method). It is understood that in some examples, transform module 308 may be skipped, and the video signals may not be transformed to the transform domain.

Quantization module 310 may be configured to quantize the coefficient of each position in the coding block to generate quantization levels of the positions. The current block may be the residual block. That is, quantization module 310 can perform a quantization process on each residual block. The residual block may include N×M positions (samples), each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 310. Which quantizer will be used for quantizing the current coefficient may depend on the information preceding the current coefficient in coding scan order. Such a quantization process is referred to as dependent quantization.

Referring to FIG. 3, encoding module 320 may be configured to encode the quantization level of each position in the coding block into the bitstream. In some embodiments, encoding module 320 may perform entropy encoding on the coding block. Entropy encoding may use various binarization methods, such as Golomb-Rice binarization, to convert each quantization level into a respective binary representation, such as binary bins. Then, the binary representation can be further compressed using entropy encoding algorithms. The compressed data may be added to the bitstream. Besides the quantization levels, encoding module 320 may encode various other information, such as block type information of a coding unit, prediction mode information, partitioning unit information, prediction unit information, transmission unit information, motion vector information, reference frame information, block interpolation information, and filtering information input from, for example, prediction modules 304 and 306. In some embodiments, encoding module 320 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined Truncated Rice (TR) and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of context-adaptive binary arithmetic coding (CABAC) can support two operating modes: a context coding mode, in which the bins are coded with adaptive probability models, and a less complex bypass mode that uses fixed probabilities of ½. The adaptive probability models are also called contexts, and the assignment of probability models to individual bins is referred to as context modeling.

As shown in FIG. 3, dequantization module 312 may be configured to dequantize the quantization levels by dequantization module 312, and inverse transform module 314 may be configured to inversely transform the coefficients transformed by transform module 308. The reconstructed residual block generated by dequantization module 312 and inverse transform module 314 may be combined with the prediction units predicted through prediction module 304 or 306 to generate a reconstructed block.

Filter module 316 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 318 may be configured to store the reconstructed block or picture calculated through filter module 316, and the reconstructed and stored block or picture may be provided to inter prediction module 304 when inter prediction is performed.

FIG. 4 illustrates a detailed block diagram of exemplary decoder 201 in decoding system 200 in FIG. 2, according to some embodiments of the present disclosure. As shown in FIG. 4, decoder 201 may include a decoding module 402, a dequantization module 404, an inverse transform module 406, an inter prediction module 408, an intra prediction module 410, a filter module 412, and a buffer module 414. It is understood that each of the elements shown in FIG. 4 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201.

When a video bitstream is input from a video encoder (e.g., encoder 101), the input bitstream may be decoded by decoder 201 in a procedure opposite to that of the video encoder. Thus, some details of decoding that are described above with respect to encoding may be skipped for ease of description. Decoding module 402 may be configured to decode the bitstream to obtain various information encoded into the bitstream, such as the quantization level of each position in the coding block. In some embodiments, decoding module 402 may perform entropy decoding (decompressing) corresponding to the entropy encoding (compressing) performed by the encoder, such as, for example, variable-length coding (VLC), context-adaptive variable-length coding (CAVLC), CABAC, syntax-based binary arithmetic coding (SBAC), PIPE coding, and the like to obtain the binary representation (e.g., binary bins). Decoding module 402 may further convert the binary representations to quantization levels using Golomb-Rice binarization, including, for example, EGk binarization and combined TR and limited EGk binarization. Besides the quantization levels of the positions in the transform units, decoding module 402 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 402 may perform rearrangement on the bitstream to reconstruct and rearrange the data from a 1D order into a 2D rearranged block through a method of inverse-scanning based on the coding scan order used by the encoder.

Dequantization module 404 may be configured to dequantize the quantization level of each position of the coding block (e.g., the 2D reconstructed block) to obtain the coefficient of each position. In some embodiments, dequantization module 404 may perform dependent dequantization based on quantization parameters provided by the encoder as well, including the information related to the quantizers used in dependent quantization, for example, the quantization step size used by each quantizer.

Inverse transform module 406 may be configured to perform inverse transformation, for example, inverse DCT, inverse discrete sine transform (DST), and inverse KLT, for DCT, DST, and KLT, LFNST, and/or NSPT performed by the encoder, respectively, to transform the data from the transform domain (e.g., coefficients) back to the pixel domain (e.g., luma and/or chroma information). In some embodiments, inverse transform module 406 may selectively perform a transform operation (e.g., DCT, DST, KLT, LFNST, NSPT) according to a plurality of pieces of information such as a prediction method, a size of the current block, a prediction direction, and the like.

For instance, while a separable transform applies one-dimensional transforms in the horizontal and vertical directions separately, a two-dimensional non-separable transform is applied directly to a block of input samples. One desirable property of transforms is for the transform vectors to span the space of the input samples. This means any input vector (e.g., any combination of values of the input samples) can be represented by a weighted sum of the transform vectors. For a transform to be spanning, one necessary condition is that there must at least be as many transform vectors as the dimensionality of the input space, or in other words, the number of transform coefficients output is at least equal to the number of input samples. For example, the one-dimensional DCTs in VVC are spanning transforms. Then, for a spanning non-separable transform, if the block of input samples is an M×N residual, the transform will also output an M×N block of transform coefficients, which may be implemented by a matrix implementation of (M×N)×(M×N) multiplications.

To derive a non-separable transform that produces coding gain for a particular directional feature, the transform may be learned. For example, a representative set of residual blocks corresponding to the directional feature of interest may be grouped, and then the Karhunen-Loeve Transform (KLT) may be calculated from the covariance matrix of the set of residual blocks. The process may be repeated over K different sets of residual blocks. Then, in this example, an overall transform kernel is derived with dimensionality (M×N)×(M×N)×K.

There are two problems with spanning non-separable transforms, as described in this section. Firstly, the computation complexity is high. Because non-separable transforms are typically learned, they cannot generally be factorized. The matrix implementation of the spanning non-separable transform in the above example results in a complexity of M×N multiplications per sample. The second problem is that the transform kernel(s) occupy a large amount of storage in the encoder 101 and decoder 201. In the above example, a single kernel adaptable to K different directional features has (M×N)×(M×N)×K weights. This kernel can only be applied to residual blocks with size M×N. To allow the application of non-separable transform to multiple block sizes, a transform kernel must be learned for each discrete block size.

In VVC, an LFNST tool was introduced with a number of modifications to address the problems described above for spanning non-separable transforms.

Firstly, while the LFNST tool applies to a wide range of block sizes, only two LFNST kernels are defined, according to a first modification. For instance, for blocks with size 4×N or N×4 (for N≥4), a smaller LFNST kernel is applied. For all larger block sizes (e.g., 8×8 or larger), a larger LFNST kernel is applied.

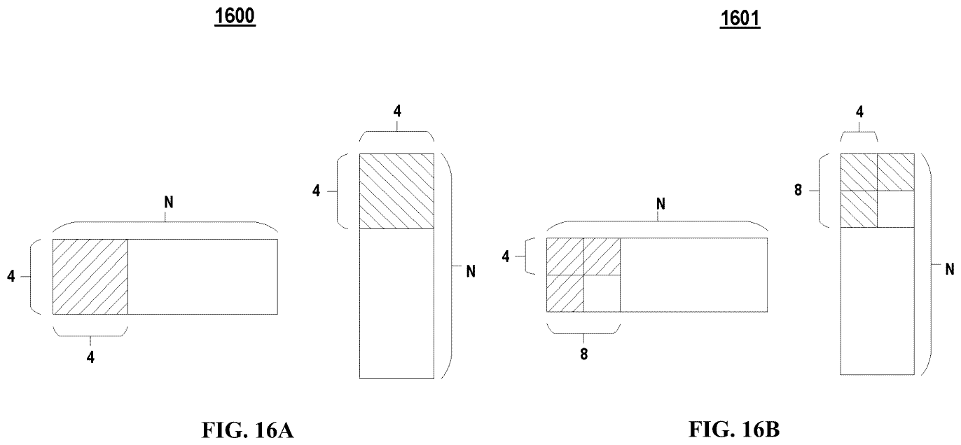

FIG. 16A illustrates a diagram 1600 of an LFNST kernel used for 4×N and N×4 block sizes in VVC, according to some embodiments of the present disclosure. FIG. 16B illustrates a diagram 1601 of LFNST kernel for 8×N and N×8 block sizes in VVC, according to some embodiments of the present disclosure.

FIGS. 16A and 16B illustrate the sample positions on which the LFNST acts. For example, from the encoder perspective and for 4×N or N×4 block sizes, the top left 4×4 sample positions (indicated by the shaded regions in FIG. 16A) are transformed by the small LFNST. The remaining sample positions (indicated by the white regions in FIG. 16A) are ignored, or “zeroed out”. From the decoder perspective, the inverse LFNST is applied to produce the top left 4×4 samples, while the remaining samples are filled in as zeros. A similar policy is applied for larger block sizes, where the LFNST acts on the 3 top left 4×4 blocks of sample positions (indicated by the shaded regions in FIG. 16B). The remaining sample positions are zeroed out.

As a consequence of the “zero out” policy, the LFNST is substantially reduced in size compared to a full size transform applying to all sample positions. However, it is inherently lossy and cannot restore the values at sample positions which are ignored by the LFNST. Such loss would be too large for the LFNST tool to be useful if it were applied directly to the residual samples. However, the LFNST is called a secondary transform because it is applied after the separable DCT at the encoder has already been performed, acting on primary transform coefficients to produce secondary transform coefficients. In other words, the DCT may be considered to be a primary transform. According to embodiments of the present disclosure, the left-most sample positions in a block of primary transform coefficients correspond to the horizontal low frequencies of the DCT, while the top-most sample positions correspond to the vertical low frequencies of the DCT. By preferentially transforming and reconstructing at decoder 201, the top-left sample positions, the LFNST is able to reconstruct the low-frequency information from the original residual. As described previously, transforms produce coding gain due to their energy compaction properties, and it has been well established that the variance (energy) of a camera-captured image and video signals is predominantly concentrated in the low frequency DCT coefficients. Therefore, while “zero out” prevents the LFNST from reconstructing an arbitrary residual block losslessly, in practice, the loss can be minimal for most classes of image and video signals.

A second modification is that for both the small and large LFNST kernels, the transform applied is not a spanning transform. From the perspective of encoder 101, the number of output (secondary transform) coefficients is less than the number of input (primary transform) coefficients. For example, the smaller LFNST kernel takes as input 4×4=16 primary transform coefficients, but produces only 8 output secondary transform coefficients. The larger LFNST kernel takes 3×4×4=48 input primary transform coefficients and outputs 8 secondary transform coefficients. The use of a non-spanning transform introduces further reconstruction loss. However, this loss can be traded off in a controlled manner against the achieved complexity reduction. A spanning non-separable transform may first be designed by the KLT method described above. By following this method, the basis vectors of the transform correspond to eigenvectors of the covariance matrix calculated from a representative set of residual blocks. These eigenvectors may be ranked in importance by their corresponding eigenvalues, with the most important eigenvectors selected to construct a non-spanning non-separable transform. For example, the 8 eigenvectors with the largest eigenvalues may be selected to form a non-spanning transform for the smaller LFNST kernel.

In summary, the two modifications described above significantly reduce the complexity of the LFNST kernel, as compared to the spanning non-separable transform. For smaller blocks, the use of the smaller LFNST kernel reduces the potential complexity from (4×N)×(4×N) multiplications per transform block (for N≥4), down to 16×8 multiplications. For larger blocks, the use of the larger LFNST kernel reduces the potential complexity from (8×N)×(8×N) multiplications per transform block (for N≥8), down to 48×8 multiplications.

The LFNST kernels do not include only one transform matrix. To achieve better coding gain over a variety of image and video signals, multiple transform matrices are learned. The number of different transform matrices is the product of the 3^{rd} and 4^{th} dimensions of the LFNST kernel: the smaller LFNST kernel has a dimensionality of 16×8×2×4, and the larger LFNST kernel has a dimensionality of 48×8×2×4. The LFNST kernel is expressed with two additional dimensions because the particular transform matrix for a transform block is selected by a mixture of explicit signaling and implicit selection.

Explicit signaling is performed by an LFNST index signaled in the bitstream that may take the value 0, 1, or 2, where 0 indicates that the LFNST is not used for the transform block, while values 1 or 2 indicate selection in the 3rd dimension of the LFNST kernel. The drawbacks of potential reconstruction loss due to the zero-out and non-spanning simplifications are ameliorated by the explicit signaling mechanism. While the use of LFNST would result in excessive reconstruction loss for a transform block, the LFNST tool can be disabled by signaling an LFNST index of 0.

Implicit selection is enabled by restricting the LFNST only to coding units that use intra prediction. Intra prediction produces a prediction block for the coding unit from adjacent neighboring reference samples to the top and left of the current block. The particular method of constructing the prediction block is signaled in the bitstream by an intra prediction mode. Simple methods of intra prediction include taking the average of the reference samples (“DC” mode), or constructing an affine interpolation between some reference samples (“planar” mode). However, the majority of the intra prediction modes are reserved for signaling intra angular directions, where the prediction block is constructed by assuming the reference sample values are replicated along a particular direction. When an intra angular direction is used, it may be a strong hint for the directional characteristics of the residual block. Implicit selection of an LFNST transform is performed by mapping the intra prediction mode to one of 4 possible values of a “transform set index”, which is used to index into the 4^{th} dimension of the LFNST kernel. The mapping used in VVC is shown in Table 1.

TABLE 1
Mapping from intra prediction mode to LFNST transform set index

| Intra prediction mode | IfnstTrSetIdx |
|---|---|
| predModeIntra < 0 | 1 |
| 0 <= predModeIntra <= 1 | 0 |
| 2 <= predModeIntra <= 12 | 1 |
| 13 <= predModeIntra <= 23 | 2 |
| 24 <= predModeIntra <= 44 | 3 |
| 45 <= predModeIntra <= 55 | 2 |
| 56 <= predModeIntra <= 80 | 1 |

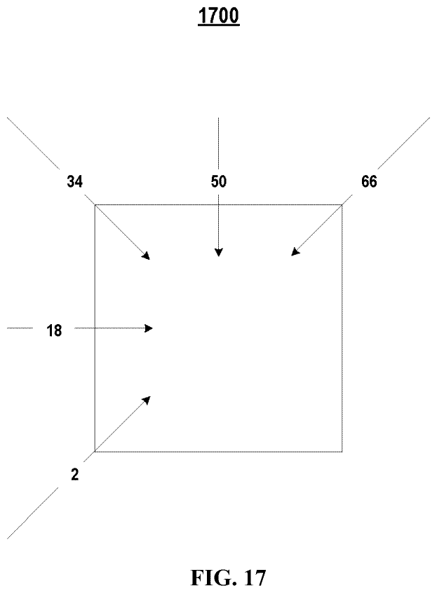

Intra prediction modes 0 and 1 correspond to intra prediction planar mode and intra DC prediction mode, respectively. These modes are handled as a special case by mapping to the transform set index 0. Otherwise, the remaining intra prediction modes correspond to intra angular directions 1700, which are partially shown in FIG. 17. Intra prediction mode 2 corresponds to a diagonal intra angular prediction from the bottom-left. Increasing intra prediction mode numbering corresponds to clockwise rotation of the intra prediction direction, with intra prediction mode 34 corresponding to diagonal intra angular prediction from the top-left, and intra prediction mode 66 corresponding to diagonal intra angular prediction from the top-right.

For intra prediction modes greater than 34, which correspond to intra angular prediction directions clockwise of diagonal from the top-left, the selected LFNST transform matrix is applied in a transpose manner for the primary transform coefficients. In one implementation, this may be performed by scanning the primary transform coefficients in a transpose direction before applying the LFNST transform. For example, from the perspective of encoder 101, if a current block is predicted by intra prediction mode 2, then the primary transform coefficients may be rearranged from their two-dimensional pattern in the block to a one-dimensional vector by a row-major scan, before applying a selected LFNST transform matrix T. Then, for this example, if the current block is instead predicted by intra prediction mode 66, and the same signaled LFNST index is used, the primary transform coefficients would instead be rearranged to a one-dimensional vector by column-major scan before applying the same LFNST transform matrix T. In another implementation, the same current block with intra prediction mode 66 can be equivalently transformed by still performing a row-major scan over the primary transform coefficients, but instead rearranging the rows of the transform matrix T.

More generally, the application of the LFNST transform matrix may be described as follows. Let the primary transform coefficient located at row y, column x be denoted as p_{x,y}, and let the LFNST transform matrix T have dimensions A×B, where A is the number of secondary transform coefficients, and B is the number of primary transform coefficients that are not zeroed out. Then, for intra prediction modes<=34, an arbitrary scan order through the primary transform coefficients p_{x,y} to construct a one-dimensional vector P may be defined by equation (8), shown below.

$$P = \{ {p}_{{x}_{0} , {y}_{0}} , {p}_{{x}_{1} , {y}_{1}} , {p}_{{x}_{2} , {y}_{2}} , ... {p}_{{x}_{B - 1} , {y}_{B - 1}} \} . \qquad ( 8 )$$

For intra prediction modes greater than 34, P is instead constructed by the transposed scan order as defined by equation (9), shown below.

$$P = \{ {p}_{{y}_{0} , {x}_{0}} , {p}_{{y}_{1} , {x}_{1}} , {p}_{{y}_{2} , {x}_{2}} , ... {p}_{{y}_{B - 1} , {x}_{B - 1}} \} . \qquad ( 9 )$$

The forward LFNST transform may be understood as the matrix multiplication S=TP, where S is a one-dimensional vector of secondary transform coefficients. In practice, the transform is implemented as S=n(TP) since all multiplications are implemented in integer arithmetic, and n(⋅) represents normalization operations necessary for the integerized LFNST to approximate the ideal transform expressed in floating point. Secondary transform coefficients are written back to the transform block in a forward diagonal scan order. Following the same notation as introduced above, and the convention that the (0,0) location corresponds to “low frequency” or “DC” in the conventional DCT, the scan order s may be defined according to equation (10), shown below.

$$S = \{ {s}_{0 , 0} , {s}_{0 , 1} , {s}_{1 , 0} , {s}_{0 , 2} , {s}_{1 , 1} , {s}_{2 , 0} , {s}_{0 , 3} , {s}_{1 , 2} , {s}_{2 , 1} , {s}_{3 , 0} , ... \} . \qquad ( 10 )$$

From the perspective of decoder 201, the inverse LFNST transform may be expressed as the matrix multiplication P=n(T^{T}S), or in other words, the inverse transform is performed by the transpose of the matrix T.

Transposition of the primary transform coefficients for intra prediction modes greater than 34 allows the same LFNST transform matrix to be shared for intra angular prediction directions that are symmetric.

In a post-VVC exploratory activity, an extension to the LFNST has been proposed and integrated into an ECM. The LFNST tool in ECM relaxes some of the complexity reductions imposed on the original LFNST tool adopted in VVC to achieve enhanced coding gain.

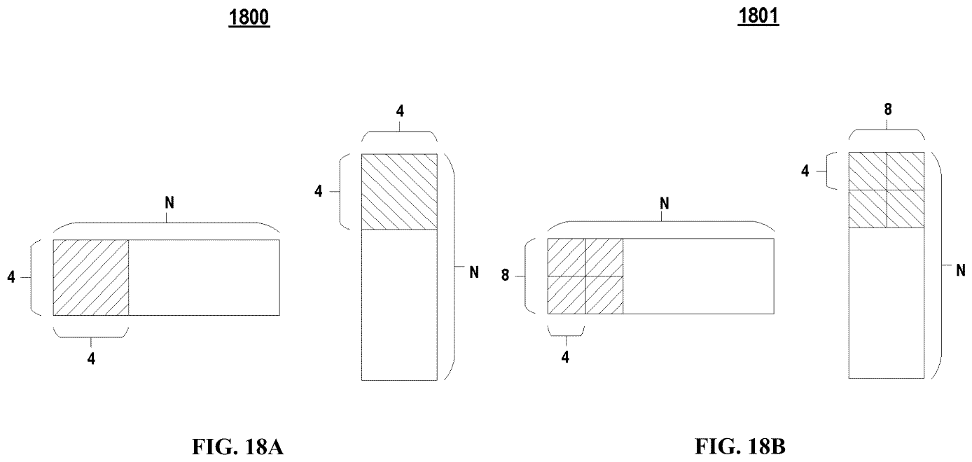

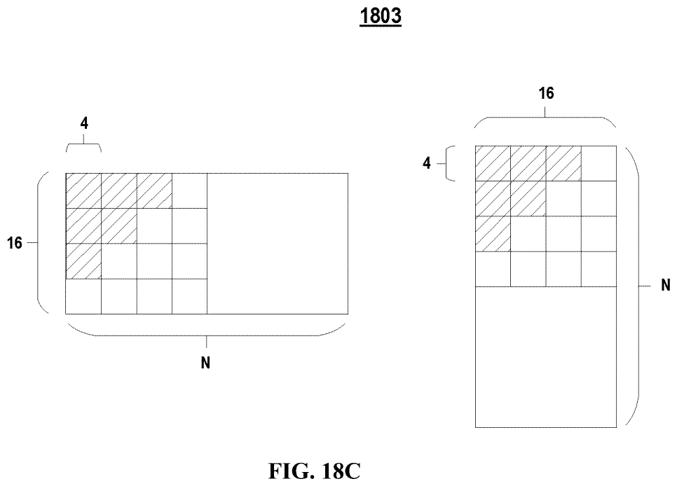

ECM has three LFNST kernels. Similar to the LFNST tool in VVC, in most cases, a significant portion of the transform block is zeroed out, as depicted in FIGS. 18A-18C. For instance, FIG. 18A illustrates a diagram 1800 of an LFNST kernel for 4×N and N×4 block sizes in ECM, according to some embodiments of the present disclosure. FIG. 18B illustrates a diagram 1801 of an LFNST kernel for 8×N and N×8 block sizes in ECM, according to some embodiments of the present disclosure. FIG. 18C illustrates a diagram 1803 of an LFNST kernel 16×16 block size in ECM, according to some embodiments of the present disclosure.

In FIGS. 18A-18C, the shaded regions indicate the primary transform coefficient positions on which the LFNST in ECM acts, while the white regions indicate which transform coefficient positions are zeroed out. For blocks with size 4×N or N×4 (where N≥4), a small LFNST kernel is used on the top left 4×4 primary transform coefficients. For blocks with size 8×N or N×8 (where N≥8), a medium LFNST kernel is used on the 4 top left 4×4 blocks of primary transform coefficients. For 16×16 or larger blocks, a large LFNST kernel is used on the 6 top left 4×4 blocks of primary transform coefficients.

The size of the LFNST kernels in ECM are 16×16×3×35 for the small LFNST kernel, 64×32×3×35 for the medium LFNST kernel, and 96×32×3×35 for the large LFNST kernel. Compared to the LFNST tool in VVC, the range of signalled LFNST indices is increased from 2 to 3, and the number of LFNST transform sets is increased from 4 to 35. This means there are 35 LFNST transform matrices per each of the 3 indices. The mapping from intra prediction mode to LFNST transform set index is shown in Table 2. Similar to the LFNST tool in VVC, when the intra prediction mode is greater than 34, then the primary transform coefficients are transposed.

TABLE 2
Mapping from intra prediction mode
to LFNST transform set index in ECM

| Intra prediction mode | IfnstTrSetIdx |
|---|---|
| predModeIntra < 0 | 2 |
| 0 <= predModeIntra <= 34 | predModeIntra |
| 35 <= predModeIntra <= 66 | 68 - predModeIntra |
| 67 <= predModeIntra <= 80 | 2 |

The complexity burden of the LFNST tool may be evaluated in three ways. Firstly, there is an additional storage burden imposed on decoder 201 because it must store the LFNST kernels. Secondly, the worst-case multiplications per sample that decoder 201 must perform if the LFNST tool is exercised. Thirdly, the additional multiplications per sample that encoder 101 uses if a full search over the LFNST tool is performed. By all three measures, the extended LFNST proposed in ECM is more complex than the LFNST of VVC. However, the worst-case decoder complexity, in terms of the total number of multiplications per sample, may still be less than the worst-case decoder complexity of other transform options.

For a matrix multiplication implementation of the DCT applied separably to an M×N size transform, the multiplications per sample are (M+N). Therefore, the worst-case complexity occurs for the largest value of (M+N). In practice, the complexity may be reduced by alternative implementations of the DCT, such as butterfly factorisation, but it is still convenient to assess the complexity of a matrix multiplication implementation. The separable DCT has been extended in ECM so that the largest transform is the 128-point DCT. Then, the worst-case complexity for the separable DCT is potentially 128+128=256 multiplications per sample.

The worst-case decoder complexity of the LFNST in ECM may be assessed by considering a number of different block sizes. For a fair comparison, the assessment includes the cost of performing the primary transform. For a 4×4 block, the primary transform includes a 4+4=8 multiplications per sample. The LFNST includes a 16×16 matrix multiplication, which is 16 multiplications per sample. Therefore, the overall cost of the LFNST for 4×4 blocks is 24 multiplications per sample.

For a 4×8 block, a naïve implementation of the DCT primary transform would usually require 8 4×4 transforms along the short dimension and 4 8×8 transforms along the long dimension, resulting in an overall 4+8=12 multiplications per sample. However, because the LFNST only reconstructs non-zero coefficient values in the top-left 4×4 block of primary transform coefficient positions, an optimized decoder would be able to take advantage by only performing 4 4×4 transforms along the short dimension, then 4 4×8 transforms along the long dimension, resulting in an overall 2+4=6 multiplications per sample. As the order of the separable transforms is generally fixed, in the worst-case scenario, decoder 201 may perform 4 4×8 transforms along the long dimension first. Then, decoder 201 may perform 8 4×4 transforms along the short dimension. This results in 4+4=8 multiplications per sample. The LFNST is still a 16×16 matrix multiplication whose cost is amortized over a larger block, resulting in 8 multiplications per sample. Then, the worst-case cost of the LFNST for 4×8 blocks is 16 multiplications per sample. The same principles apply generally for 4×N or N×4 block sizes. Therefore, the multiplications per sample for 4×N or N×4 blocks will always be less than or equal to the multiplications per sample for 4×4 blocks.

For an 8×8 block, the primary transform consists of 8+8=16 multiplications per sample. The LFNST consists of a 64×32 matrix multiplication, which is 32 multiplications per sample. Then, the overall cost of the LFNST for 8×8 blocks is 48 multiplications per sample.

For an 8×16 block, it is again assumed that decoder 201 takes advantage of the zero-out properties of LFNST reconstruction. Only the top left 8×8 block of primary transform coefficient positions is non-zero. Decoder 201 may take advantage of this by only performing 8 8×8 transforms along the short dimension. Then, decoder 201 may perform 8 8×16 transforms along the long dimension. This results in an overall 4+8=12 multiplications per sample. Alternatively, decoder 201 may perform 8 8×16 transforms along the long dimension first. Then, decoder 201 may perform 16 8×8 transforms along the short dimension. This may result in 8+8=16 multiplications per sample. The LFNST adds another (64×32)/(8×16)=16 multiplications per sample, resulting in an overall worst-case complexity of 32 multiplications per sample. As before, the multiplications per sample for 8×N or N×8 blocks are always less than or equal to the multiplications per sample for 8×8 blocks.

For a 16×16 block, the zero-out properties of LFNST reconstruction mean that only six 4×4 blocks of primary transform coefficients in the pattern (as shown in FIG. 18C) have non-zero values. For simplicity, let us assume a more relaxed pattern where the top-left 12×12 block of primary transform positions may have non-zero values. First, decoder may take advantage of this by only performing 12 12×16 transforms in one dimension. Then, decoder 201 may perform 16 12×16 transforms in the second dimension, which includes 9+12=21 multiplications per sample. The LFNST includes (96×32)/(16×16)=12 multiplications per sample, resulting in an overall complexity of 33 multiplications per sample.

For an M×N block where M, N≥16, decoder 201 may first perform 12 12×M transforms in one dimension. Then, decoder 201 may perform M 12×N transforms in the second dimension, resulting in (12×12)/N+12 multiplications per sample to perform the separable DCT. Then, the worst-case complexity occurs for the smallest value of N=16, which is 21 multiplications per sample and equal to the complexity for 16×16 blocks. The LFNST adds another (96×32)/(M×N) multiplications per sample, which is always less than or equal to the multiplications per sample for 16×16 blocks. Therefore, the overall complexity of the LFNST in ECM for larger M×N block sizes is always equal to or less than the multiplications per sample for 16×16 blocks.

After assessing the decoder complexity of the LFNST in ECM exhaustively across different block sizes, it is shown that the worst-case complexity is 48 multiplications per sample (occurring in the case of 8×8 blocks). This worst-case complexity includes the cost of performing the separable DCT with matrix multiplication implementation, but due to optimizations possible from LFNST zero-out, it is significantly less than the worst-case complexity of performing the separable DCT alone (which is assessed as 256 multiplications per sample). If assuming a more practical implementation of the separable DCT with butterfly factorization, then the worst-case complexity of the LFNST still occurs for 8×8 blocks, with a cost of 32 multiplication per sample from the LFNST, plus the cost of the butterfly DCT. In such a case, the LFNST may be the worst case compared with the cost of butterfly DCT applied separably to 256×256 size blocks.

As seen above, the use of non-separable secondary transform allows significant complexity reductions due to the use of zero-out on selected primary transform coefficient regions. However, further coding may be possible with an NSPT. An initial study on non-separable primary transforms found that significant gains (3.43% average rate reduction by the Bjontegaard metric) could be achieved, although the transforms implemented were complex, and the kernel weights were obtained by overfitting the test data set.

A practical implementation of NSPT is proposed. For instance, the NSPT may only be applied to a small set of block sizes: 4×4, 4×8, 8×4, and 8×8. For these block sizes, the NSPT replaces both primary transform and LFNST. As with the LFNST, the NSPT kernels are trained, with a selection of an appropriate matrix for a particular block guided by both a signalled index and implicit selection through the intra prediction mode. Four NSPT kernels are proposed. For 4×4 blocks, a small NSPT kernel with dimensions 16×16×3×35 is used. For 4×8 and 8×4 blocks, medium NSPT kernels with dimensions of 32×20×3×35 are used. For 8×8 blocks, a large NSPT kernel with dimensions 64×32×3×35 is used.

According to the present disclosure, a zero-out approach may be defined as a reduction in the input dimension of the transform kernel, which in the notation of the transform kernel dimensions of this disclosure corresponds to the first dimension. A reduction in the input dimension of the forward transform is equivalent to a reduction of the support for the transform. For example, the LFNST zero-out corresponds to a reduction of the number of DCT primary transform coefficients that the forward LFNST acts on to produce secondary transform coefficients. In the proposed NSPT, the transform acts directly on the residual coefficients, so a reduction of the first dimension of an NSPT kernel includes a reduction in the number of residual coefficients that the forward NSPT acts on to produce primary transform coefficients. In the known proposal mentioned above, the size of each NSPT kernel's first dimension is always equal to the number of samples in the block, so zero-out, according to the definition in this disclosure, is not used. However, in this known proposal, zero-out is instead defined as a reduction in the output dimension of the transform kernel, which in the notation of transform kernel dimensions in this disclosure is the second dimension. Such definition is not ambiguous in that proposal since no reduction is ever performed on the input side of the NSPT kernel, and gives an example of the term “zero-out” being used more generally. However, for consistency and clarity within this disclosure, “zero-out” is defined to describing a reduction in the input dimension of a transform kernel, while labeling a reduction of the output dimension as a non-spanning, or lossy transform. For the medium and large NSPT kernels the second dimension is smaller than the first dimension, meaning that the NSPT in these cases is a lossy transform.

As with the LFNST, an NSPT index is signaled in the bitstream that may take the value 0, 1, 2, or 3, where 0 indicates that the NSPT is not used for the transform block, while values 1-3 indicate selection within the corresponding NSPT kernel along the 3rd dimension. Selection along the 4th dimension of the NSPT kernel is determined by mapping from the intra prediction mode as shown in Table 3, in the same manner as for the extended LFNST in ECM. As with the LFNST, when the intra prediction mode is greater than 34 (which means the intra angular direction is clockwise of the diagonal top-left direction), the input to the transform is transposed. However, for the NSPT, the input is composed of residual coefficients, not primary transform coefficients.

TABLE 3
Mapping from intra prediction mode
to NSPT transform set index in ECM

| Intra prediction mode | nsptTrSetIdx |
|---|---|
| predModeIntra < 0 | 2 |
| 0 <= predModeIntra <= 34 | predModeIntra |
| 35 <= predModeIntra <= 66 | 68 - predModeIntra |
| 67 <= predModeIntra <= 80 | 2 |

For an M×N shape residual block, and when the intra prediction mode is less than or equal to 34, let the residual sample located at row y, column x be denoted r_{x,y}, and let an LFNST transform matrix T selected from the NSPT kernel for M×N shaped blocks have dimensions A×B, where A is the number of primary transform coefficients, and B=M×N is the number of residual samples in the block. Then, an arbitrary scan order through the residual samples to construct a one-dimensional vector R may be defined according to equation (11), shown below.

$$R = \{ {r}_{{x}_{0} , {y}_{0}} , {r}_{{x}_{1} , {y}_{1}} , {r}_{{x}_{2} , {y}_{2}} , ... {r}_{{x}_{B - 1} , {y}_{B - 1}} \} . \qquad ( 11 )$$

For intra prediction modes greater than 34, R is instead constructed by the transposed scan order, according to equation (12).

$$R = \{ {r}_{{y}_{0} , {x}_{0}} , {r}_{{y}_{1} , {x}_{1}} , {r}_{{y}_{2} , {x}_{2}} , ... {r}_{{y}_{B - 1} , {x}_{B - 1}} \} . \qquad ( 12 )$$

Additionally, when the intra prediction mode is greater than 34, the LFNST transform matrix T is selected instead from the NSPT kernel for N×M shaped blocks. For square block shapes, this is the same kernel, so T is the same transform matrix. However, in the case of 4×8 or 8×4 block sizes, the transform matrix is selected from a different NSPT kernel.

The forward NSPT transform may be implemented as P=n(TR), where P is a one-dimensional vector of NSPT transform coefficients, and n( ) denotes normalization operations necessary for the integerised NSPT to approximate the ideal transform expressed in floating point. Transform coefficients are written back to the transform block in a forward diagonal scan order. Following the same notation as introduced above, and the convention that the (0,0) location corresponds to “low frequency” or “DC” in the conventional DCT, the scan order is described according to equation (13).

$$P = \{ {p}_{0 , 0} , {p}_{0 , 1} , {p}_{1 , 0} , {p}_{0 , 2} , {p}_{1 , 1} , {p}_{2 , 0} , {p}_{0 , 3} , {p}_{1 , 2} , {p}_{2 , 1} , {p}_{3 , 0} , ... \} . \qquad ( 13 )$$

From the perspective of decoder 201, the inverse NSPT transform may be expressed as the matrix multiplication R=n(T^{T}P), or in other words, the inverse transform is performed by the transpose of the matrix T.

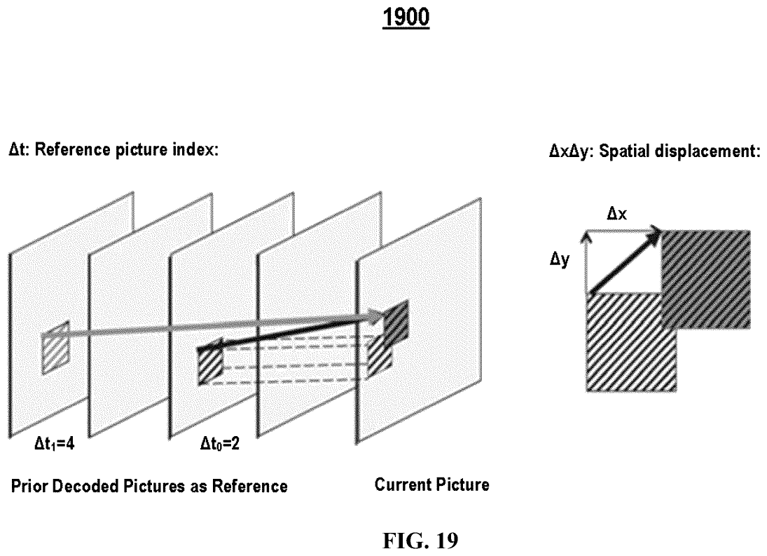

FIG. 19 illustrates an example visualization of an inter prediction mode 1900, according to some aspects of the present disclosure.

For inter-coded CUs (also expressed as inter CUs in this disclosure), reconstructed samples in temporal reference frames are used to predict the current block and the inter prediction mode is signaled once for the entire CU. Inter-picture prediction makes use of the temporal correlation between pictures in order to derive a motion-compensated prediction (MCP) for a block of image samples.

For this block-based MCP, a video picture is divided into rectangular blocks. Assuming homogeneous motion inside one block, for each block, a corresponding block in a previously decoded picture can be found that serves as a predictor. The general concept of MCP based on a translational motion model is illustrated in FIG. 19. Using a translational motion model, the position of the block in a previously decoded picture is indicated by a motion vector (mvₓ, mv_{y}), where mvₓ and mv_{y} specify the horizontal and the vertical displacements relative to the position of the current block along horizontal and vertical directions, respectively. The motion vector (mvₓ, mv_{y}) could be of fractional sample accuracy to more accurately capture the movement of the underlying object. Interpolation is applied on the reference pictures to derive the prediction signal when the corresponding motion vector has fractional sample accuracy. The previously decoded picture is referred to as the reference picture and indicated by a reference index Δt to a reference picture list. These translational motion model parameters, e.g., motion vectors and reference indices, are further referred to as motion data. Two kinds of inter-picture prediction are allowed in modern video coding standards, namely uni-prediction and bi-prediction. In case of bi-prediction, two sets of motion data (mvₓ₀, mv_{y0}, Δt0) and (mvₓ₁, mv_{y1}, Δt1) are used to generate two MCPs (possibly from different pictures), which are then combined to get the final MCP. Furthermore, multiple hypotheses (more than two) may be employed to form the final inter prediction. The same or different weights can be applied to each MCP. The reference pictures that can be used in bi-prediction are stored in two separate lists, namely list 0 and list 1. Motion data is derived at the encoder 101 using a motion estimation process. Motion estimation is not specified within video standards so different encoders can utilize different complexity-quality tradeoffs in their implementations.

The motion data of a block may be correlated with the neighboring blocks. To exploit this correlation, motion data is not directly coded in the bitstream but predictively coded based on neighboring motion data. The predictive coding of the motion vectors may be coded with advanced motion vector prediction (AMVP) where the best predictor for each motion block is signaled to the decoder. In addition, an inter-prediction block merging derives all motion data of a block from the neighboring, including both spatial and temporal blocks. Similar to intra prediction, the residual between original pixels and inter prediction may be further transformed and then coded into the bitstream.

Using existing techniques, reference blocks are directly copied from a reconstructed area of previous reference frames and then a weighted summation of these reference blocks serves as a prediction block for the current block when inter mode is selected. The prediction accuracy may be unduly limited because it does not consider any spatial information among neighbouring pixels.

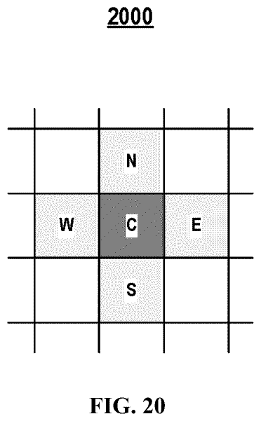

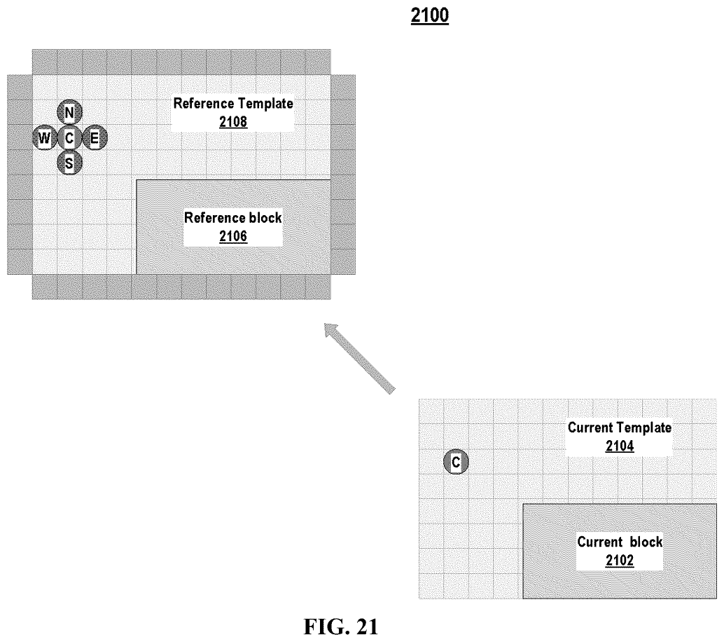

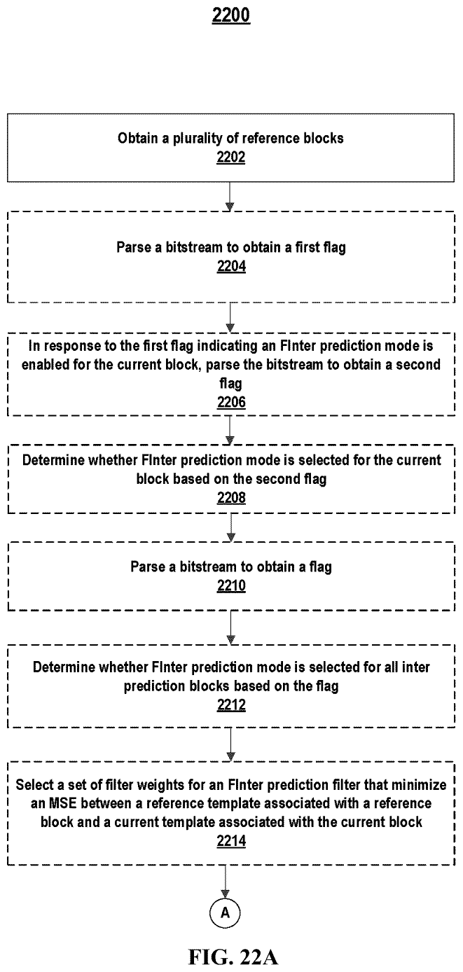

To overcome these and other challenges, the present disclosure provides a filtered inter (Finter) prediction mode. In some implementations, where the reconstructed pixels within a reference block pointed at by an inter motion vector (mvₓ, mv_{y}) are further filtered with an online-learned filter. Rather than the reference block, the resulting filtered block (uni-prediction) or a summation of multiple weighted filtered blocks (bi or multi-hypothesis) is used as the predictor for the current block. In some implementations, multiple reference blocks may be determined through multiple motion data signalling to form a final predictor for the current CU. Here, a final predictor is produced by further filtering a fused combination of reference blocks with a learned filter. Additional details of the exemplary Finter prediction mode are provided below in connection with FIGS. 20 and 21.

FIG. 20 illustrates an example visualization of the spatial support of a learned filter 2000 (referred to hereinafter as “filter 2000”), according to some embodiments of the present disclosure. FIG. 21 illustrates an example visualization of a reference block/template for filtered inter (FInter) prediction 2100 where a reference block 2106 is identified by a motion vector (mvₓ, mv_{y}), according to some embodiments of the present disclosure. FIGS. 20 and 21 will be described together.

Referring to FIG. 20, inter prediction module 408 may apply the filter 2000 for FInter prediction as a shift-invariant weighting over a region of support that moves over the reconstructed block. Let R and F be the reference block and the filtered predictor block, respectively, and let R_{x,y} and F_{x,y} denote the sample and filtered sample at the xth column and yth row of R and F. The filter may be applied according to equation (14).

$${F}_{x , y} = b * B + {\sum }_{i , j ∈ S} ( {a}_{i , j} * {R}_{x + i , y + j} ) , \qquad ( 14 )$$

where a_{i,j} and b are the learned filtered weights that are adaptively adjusted using the pixels of the reconstructed block, B is a bias term that may be set as the middle luma value of the input video depth (for example, 512 for 10-bit video), and S is a finite region of the filter's support.

Filter 2000 may include one bias weight and five spatial weights at a central “C” position and the four adjacent “W”, “N”, “E” and “S” positions. In this example, the support region S={(0,0), (−1,0), (0,1), (1,0), (0,−1)}, where (0, 0), (−1, 0), (0, 1), (1, 0), and (0,−1) denote the positions of C, W, N, E, and S, respectively.

In some implementations, the support region may have a different shape and size. Additionally and/or alternatively, the filter may be augmented by non-linear terms. For example, the square of pixel values of some positions in a support region S₂ may be used. In one example, the support region of the squared terms is S₂={(0,0)}—e.g., the value of the central position is squared. A filter including squared non-linear terms may be applied according to equation (15).

$${F}_{x , y} = b * B + {\sum }_{i , j ∈ S} ( {a}_{i , j} * {R}_{x + i , y + j} ) + {\sum }_{i , j ∈ {S}_{2}} ( {c}_{i , j} * {( {R}_{x + i , y + j} )}^{2} ) . \qquad ( 15 )$$

Inter prediction module 408 may learn the weights of the filter by minimising the error between the reference block's template and the current block's template. One example of this with L-shaped templates (e.g., the current template 2104 and/or the reference template 2108) is shown in FIG. 21. However, the templates may take other shapes, such as above rectangular, or left rectangular. Let RT and CT be the reference template 2108 of the reference block 2106 and the current template 2104 of the current block 2102, respectively; and let RT_{x,y} and CT_{x,y} denote the sample at the xth column and yth row of RT and CT. Then, the filter weights are chosen to minimise the mean-square error (MSE) between the filtered RT and the current block's template, according to equation (16).

$${min}_{b , {a}_{i , j}} {\sum }_{x , y ϵ template} {[ {CT}_{x , y} - ( b * B + {\sum }_{i , j ∈ S} ( {a}_{i , j} * {RT}_{x + i , y + j} ) ) ]}^{2} . \qquad ( 16 )$$

This is a minimisation of a quadratic cost function, which may be expressed as solving a set of linear equations, and equivalently solved by inverting a matrix representing the set of linear equations. For the regular structure produced by a shift-invariant filter, the solution can be efficiently calculated. For example, the matrix may first be decomposed by an LDL decomposition, whose sub-components can then be efficiently inverted.

When solving for the filter coefficients, and when applying the learned filter, the support of the filter may extend beyond the region of samples that are available, as shown by the blue area in FIG. 21. In such cases boundary padding is used to generate values for these areas.

For bi-prediction and multiple hypothesis predictions, inter prediction module 408 may learn multiple filters separately by using the templates around the multiple reference blocks indicated by the corresponding multiple motion data and the current block. Inter prediction module 408 may first filter reference blocks separately with the corresponding learned filters. Then, inter prediction module 408 may fuse the multiple filtered reference blocks together to form a final prediction. The entire bi-prediction and multiple hypothesis process may be similar to inter prediction, except the filtered reference blocks, instead of the reference blocks themselves, are proposed to be used to generate the final prediction.

One high level flag may be signaled if FInter is allowed, e.g., at sequence parameter set (SPS), picture header (PH), picture parameter set (PPS) or slice header. If the FInter prediction mode is enabled for the current video sequence and the current CU is predicted by inter prediction, one additional flag is signaled to indicate if the original inter prediction or FInter is used.

In some implementations, FInter may replace the original inter prediction mode completely. That is, the FInter high level flag will instead signal whether the FInter prediction mode is used for all inter prediction blocks.

In some other implementations, inter prediction module 408 may determine multiple reference blocks through multiple motion data signalling to form a final predictor for the current CU. Let the reference blocks be R¹, R², . . . Rⁿ, and let the fused combination of the reference blocks be P=w₁R¹+w₂R²+ . . . wₙRⁿ for some fusion weights satisfying Σₖwₖ=1. Then, in this implementation, inter prediction module 408 may produce a final predictor by further filtering the fused combination with a learned filter, according to equation (17).

$${F}_{x , y} = b * B + {\sum }_{i , j ∈ S} ( {a}_{i , j} * {P}_{x + i , y + j} ) . \qquad ( 17 )$$

Inter prediction module 408 may learn the filter weights by minimising the weighted error between each of the reference blocks' templates RT¹, RT², . . . RTⁿ and the current block's template, according to equation (18).

$${min}_{b , {a}_{i , j}} {\sum }_{x , y} {[ \begin{matrix}{CT}_{x , y} - b * B - {w}_{1} \\ - {w}_{2} \\ ⋮ \\ - {w}_{n}\end{matrix} ]}^{2} . \qquad ( 18 )$$

Referring again to FIG. 4, additionally and/or alternatively, inter prediction module 408 and intra prediction module 410 may be configured to generate a prediction block based on information related to the generation of a prediction block provided by decoding module 402 and information of a previously decoded block or picture provided by buffer module 414. As described above, if the size of the prediction unit and the size of the transform unit are the same when intra prediction is performed in the same manner as the operation of the encoder, intra prediction may be performed on the prediction unit based on the pixel existing on the left side, the pixel on the top-left side, and the pixel on the top of the prediction unit. However, if the size of the prediction unit and the size of the transform unit are different when intra prediction is performed, intra prediction may be performed using a reference pixel based on a transform unit.

For example, inter prediction module 408 may be configured to receive a bitstream that includes a reference frame, a current frame, and an indication of a weighting factor associated with a multimedia home platform (MHP) procedure from an encoder. Inter prediction module 408 may be configured to perform the MHP procedure for a CU located in the current frame based on a search block (e.g., reference frame and/or reference template) in the reference frame. In some embodiments, to perform the MHP procedure, the inter prediction module 408 may be configured to perform template matching for the CU located in the current frame based on a search block in the reference frame and the weighting factor to obtain motion information. In some embodiments, to perform the MHP procedures, inter prediction module 408 may be configured to identify a weighting factor index associated with the weighting factor based on the template matching. Inter prediction module 408 may be configured to identify a weighting factor sign of the weighting factor based on an indication included in the bitstream. Inter prediction module 408 may be configured to perform an inter prediction procedure based on the current frame, the reference frame, the weighting factor index, and the weighting factor sign of the weighting factor to decode the bitstream.

The reconstructed block or reconstructed picture combined from the outputs of inverse transform module 406 and prediction module 408 or 410 may be provided to filter module 412. Filter module 412 may include a deblocking filter, an offset correction module, and an ALF. Buffer module 414 may store the reconstructed picture or block and use it as a reference picture or a reference block for inter prediction module 408 and may output the reconstructed picture.

Consistent with the scope of the present disclosure, encoding module 320 and decoding module 402 may be configured to adopt a scheme of quantization level binarization with Rice parameter adapted to the bit depth and/or the bit rate for encoding the picture of the video to improve the coding efficiency.

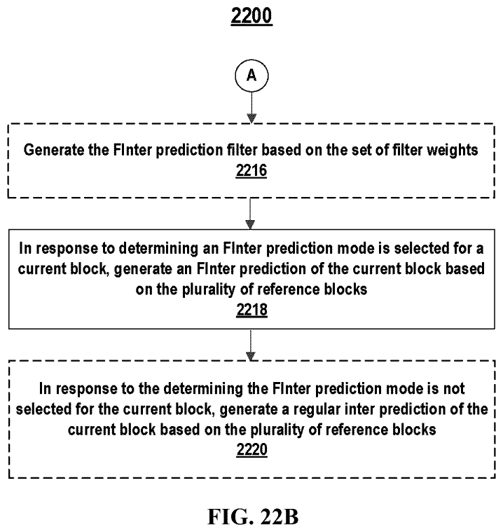

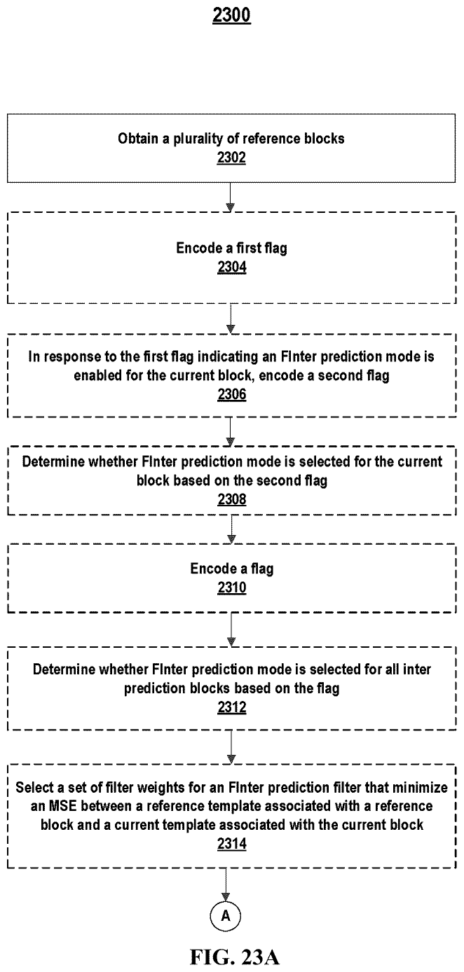

FIGS. 22A and 22B illustrate a flowchart of an exemplary method 2200 of decoding, according to some embodiments of the present disclosure. Method 2200 may be performed by a system, e.g., such as decoding system 200, decoder 201, or inter prediction module 408, just to name a few. Method 2200 may include operations 2202-2220, as described below. It is to be appreciated that some of the steps may be optional, and some of the steps may be performed simultaneously, or in a different order than shown in FIGS. 22A and 22B.

Referring to FIG. 22A, at 2202, the system may obtain a plurality of reference blocks. In some implementations, the obtaining, by a processor, the plurality of reference blocks may include parsing a bitstream to obtain a plurality of motion data. In some implementations, the obtaining, by a processor, the plurality of reference blocks may include generating the plurality of reference blocks based on the plurality of motion data. For example, referring to FIG. 4, inter prediction module 408 may obtain a plurality of reference blocks. In some examples, inter prediction module 408 may obtain the reference blocks based on motion data.

At 2204, the system may parse a bitstream to obtain a first flag. In some implementations, the first flag may be signaled at an SPS level, a PH level, a PPS level, or an SH level. For example, referring to FIG. 4, inter prediction module 408 may parse a bitstream to obtain a first flag. The first flag may indicate whether an FInter prediction mode is enabled for the current block.

At 2206, the system may, in response to the first flag indicating an FInter prediction mode is enabled for the current block, parse the bitstream to obtain a second flag. For example, referring to FIG. 4, inter prediction module 408 may parse the bitstream to obtain a second flag when the first flag indicates FInter prediction mode is enabled. The second flag may indicate whether regular inter prediction or FInter prediction is selected for the current block.

At 2208, the system may determine whether FInter prediction mode is selected for the current block based on the second flag. For example, referring to FIG. 4, inter prediction module 408 may determine whether FInter prediction mode is selected for the current block based on the second flag. For instance, a second flag with a first value may indicate FInter prediction is selected, while a second flag with a second value may indicate regular inter prediction is selected.

At 2210, the system may parse a bitstream to obtain a flag. For example, referring to FIG. 4, inter prediction module 408 may parse the bitstream to obtain a single flag when FInter prediction mode replaces regular inter prediction mode.

At 2212, the system may determine whether FInter prediction mode is selected for all inter prediction blocks based on the flag. For example, referring to FIG. 4, inter prediction module 408 may determine that FInter prediction mode is selected for all inter prediction blocks when the single flag has a first value, and determine that FInter prediction mode is not selected for all inter prediction blocks when the single flag has a second value.

At 2214, the system may select a set of filter weights for an FInter prediction filter that minimize an MSE between a reference template associated with a reference block and a current template associated with the current block. For example, referring to FIG. 4, inter prediction module 408 may learn/select the filter weights by minimising the weighted error between each of the reference blocks' templates RT¹, RT², . . . RTⁿ and the current block's template, according to equation (18). In some implementations, inter prediction module 408 may choose the filter weights to minimise the mean-square error (MSE) between the filtered RT and the current block's template, according to equation (16).

Referring to FIG. 22B, at 2216, the system may generate the FInter prediction filter based on the set of filter weights. In some implementations, the FInter prediction of the current block may further be generated based on the FInter prediction filter. For example, referring to FIG. 4, inter prediction module 408 may generate the FInter prediction filter based on the selected filter weights.

At 2218, the system, in response to determining an FInter prediction mode is selected for a current block, generates an FInter prediction of the current block based on the plurality of reference blocks. In some implementations, in response to determining the FInter prediction mode is selected for a current block, the generating, by the processor, the FInter prediction of the current block based on the plurality of reference blocks may include filtering each of the plurality of reference blocks separately using a corresponding filter to obtain a plurality of filtered reference blocks. In some implementations, in response to determining the FInter prediction mode is selected for a current block, the generating, by the processor, the FInter prediction of the current block based on the plurality of reference blocks may include fusing the plurality of filtered reference blocks to obtain a fused plurality of filtered reference blocks. In some implementations, in response to determining the FInter prediction mode is selected for a current block, the generating, by the processor, the FInter prediction of the current block based on the plurality of reference blocks may include generating the FInter prediction of the current block based on the fused plurality of filtered reference blocks. For example, referring to FIG. 4, for bi-prediction and multiple hypothesis predictions, inter prediction module 408 may learn multiple filters separately by using the templates around the multiple reference blocks indicated by the corresponding multiple motion data and the current block. Inter prediction module 408 may first filter reference blocks separately with the corresponding learned filters. Then, inter prediction module 408 may fuse the multiple filtered reference blocks together to form a final prediction. The entire bi-prediction and multiple hypothesis process may be similar to inter prediction, except the filtered reference blocks, instead of the reference blocks themselves, are proposed to be used to generate the final prediction. In some other implementations, in response to determining the FInter prediction mode is selected for a current block, the generating, by the processor, the FInter prediction of the current block based on the plurality of reference blocks may include fusing the plurality of reference blocks to obtain a fused plurality of reference blocks. In some other implementations, in response to determining the FInter prediction mode is selected for a current block, the generating, by the processor, the FInter prediction of the current block based on the plurality of reference blocks may include filtering the fused plurality of reference blocks to obtain a fused plurality of filtered reference blocks. In some other implementations, in response to determining the FInter prediction mode is selected for a current block, the generating, by the processor, the FInter prediction of the current block based on the plurality of reference blocks may include generating the FInter prediction of the current block based on the fused plurality of filtered reference blocks. For example, referring to FIG. 4, inter prediction module 408 may determine multiple reference blocks through multiple motion data signalling to form a final predictor for the current CU. Let the reference blocks be R¹, R², . . . Rⁿ, and let the fused combination of the reference blocks be P=w₁R¹+w₂R²+ . . . wₙRⁿ for some fusion weights satisfying Σₖwₖ=1. Then, in this implementation, inter prediction module 408 may produce a final predictor by further filtering the fused combination with a learned filter, according to equation (17).

At 2220, the system, in response to determining the FInter prediction mode is not selected for the current block, generates a regular inter prediction of the current block based on the plurality of reference blocks. For example, referring to FIG. 4, inter prediction module 408 may generate a regular inter prediction of the current block when FInter prediction mode is not selected for the current block.

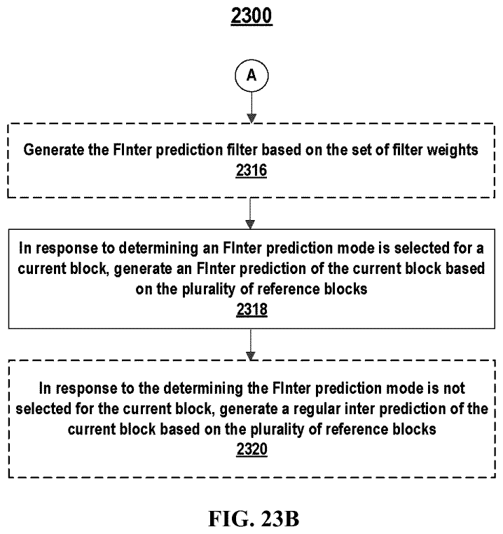

FIGS. 23A and 23B illustrate a flowchart of an exemplary method 2300 of encoding, according to some embodiments of the present disclosure. Method 2300 may be performed by a system, e.g., such as encoding system 100, encoder 101, or inter prediction module 304, just to name a few. Method 2300 may include operations 2302-2320, as described below. It is to be appreciated that some of the steps may be optional, and some of the steps may be performed simultaneously, or in a different order than shown in FIGS. 23A and 23B.

Referring to FIG. 23A, at 2302, the system may obtain a plurality of reference blocks. In some implementations, the obtaining, by a processor, the plurality of reference blocks may include encoding a plurality of motion data. In some implementations, the obtaining, by a processor, the plurality of reference blocks may include generating the plurality of reference blocks based on the plurality of motion data. For example, referring to FIG. 3, inter prediction module 304 may obtain a plurality of reference blocks. In some examples, inter prediction module 304 may obtain the reference blocks based on motion data.

At 2304, the system may encode a first flag. In some implementations, the first flag may be signaled at an SPS level, a PH level, a PPS level, or an SH level. For example, referring to FIG. 3, inter prediction module 304 may encode a first flag. The first flag may indicate whether an FInter prediction mode is enabled for the current block.

At 2306, the system may, in response to the first flag indicating an FInter prediction mode is enabled for the current block, encode a second flag. For example, referring to FIG. 3, inter prediction module 304 may encode a second flag when the first flag indicates FInter prediction mode is enabled. The second flag may indicate whether regular inter prediction or FInter prediction is selected for the current block.

At 2308, the system may determine whether FInter prediction mode is selected for the current block based on the second flag. For example, referring to FIG. 3, inter prediction module 304 may determine whether FInter prediction mode is selected for the current block based on the second flag. For instance, a second flag with a first value may indicate FInter prediction is selected, while a second flag with a second value may indicate regular inter prediction is selected.

At 2310, the system may encode a flag. For example, referring to FIG. 3, inter prediction module 304 may encode a single flag when FInter prediction mode replaces regular inter prediction mode.

At 2312, the system may determine whether FInter prediction mode is selected for all inter prediction blocks based on the flag. For example, referring to FIG. 3, inter prediction module 304 may determine that FInter prediction mode is selected for all inter prediction blocks when the single flag has a first value, and determine that FInter prediction mode is not selected for all inter prediction blocks when the single flag has a second value.

At 2314, the system may select a set of filter weights for an FInter prediction filter that minimize an MSE between a reference template associated with a reference block and a current template associated with the current block. For example, referring to FIG. 3, inter prediction module 304 may learn/select the filter weights by minimising the weighted error between each of the reference blocks' templates RT¹, RT², . . . RTⁿ and the current block's template, according to equation (18). In some implementations, inter prediction module 304 may choose the filter weights to minimise the mean-square error (MSE) between the filtered RT and the current block's template, according to equation (16).

Referring to FIG. 23B, at 2316, the system may generate the FInter prediction filter based on the set of filter weights. In some implementations, the FInter prediction of the current block may further be generated based on the FInter prediction filter. For example, referring to FIG. 3, inter prediction module 304 may generate the FInter prediction filter based on the selected filter weights.

At 2318, the system, in response to determining an FInter prediction mode is selected for a current block, generates an FInter prediction of the current block based on the plurality of reference blocks. In some implementations, in response to determining the FInter prediction mode is selected for a current block, the generating, by the processor, the FInter prediction of the current block based on the plurality of reference blocks may include filtering each of the plurality of reference blocks separately using a corresponding filter to obtain a plurality of filtered reference blocks. In some implementations, in response to determining the FInter prediction mode is selected for a current block, the generating, by the processor, the FInter prediction of the current block based on the plurality of reference blocks may include fusing the plurality of filtered reference blocks to obtain a fused plurality of filtered reference blocks. In some implementations, in response to determining the FInter prediction mode is selected for a current block, the generating, by the processor, the FInter prediction of the current block based on the plurality of reference blocks may include generating the FInter prediction of the current block based on the fused plurality of filtered reference blocks. For example, referring to FIG. 3, for bi-prediction and multiple hypothesis predictions, inter prediction module 304 may learn multiple filters separately by using the templates around the multiple reference blocks indicated by the corresponding multiple motion data and the current block. Inter prediction module 304 may first filter reference blocks separately with the corresponding learned filters. Then, inter prediction module 304 may fuse the multiple filtered reference blocks together to form a final prediction. The entire bi-prediction and multiple hypothesis process may be similar to inter prediction, except the filtered reference blocks, instead of the reference blocks themselves, are proposed to be used to generate the final prediction. In some other implementations, in response to determining the FInter prediction mode is selected for a current block, the generating, by the processor, the FInter prediction of the current block based on the plurality of reference blocks may include fusing the plurality of reference blocks to obtain a fused plurality of reference blocks. In some other implementations, in response to determining the FInter prediction mode is selected for a current block, the generating, by the processor, the FInter prediction of the current block based on the plurality of reference blocks may include filtering the fused plurality of reference blocks to obtain a fused plurality of filtered reference blocks. In some other implementations, in response to determining the FInter prediction mode is selected for a current block, the generating, by the processor, the FInter prediction of the current block based on the plurality of reference blocks may include generating the FInter prediction of the current block based on the fused plurality of filtered reference blocks. For example, referring to FIG. 3, inter prediction module 304 may determine multiple reference blocks through multiple motion data signalling to form a final predictor for the current CU. Let the reference blocks be R¹, R², . . . Rⁿ, and let the fused combination of the reference blocks be P=w₁R¹+w₂R²+ . . . wₙRⁿ for some fusion weights satisfying Σₖwₖ=1. Then, in this implementation, inter prediction module 304 may produce a final predictor by further filtering the fused combination with a learned filter, according to equation (17).

At 2320, the system, in response to the determining the FInter prediction mode is not selected for the current block, generates a regular inter prediction of the current block based on the plurality of reference blocks. For example, referring to FIG. 3, inter prediction module 304 may generate a regular inter prediction of the current block when FInter prediction mode is not selected for the current block.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of decoding is provided. The method may include obtaining, by a processor, a plurality of reference blocks. The method may include, in response to determining an FInter prediction mode is selected for a current block, generating, by the processor, an FInter prediction of the current block based on the plurality of reference blocks.

In some implementations, in response to determining the FInter prediction mode is selected for a current block, the generating, by the processor, the FInter prediction of the current block based on the plurality of reference blocks may include filtering, by the processor, each of the plurality of reference blocks separately using a corresponding filter to obtain a plurality of filtered reference blocks. In some implementations, in response to determining the FInter prediction mode is selected for a current block, the generating, by the processor, the FInter prediction of the current block based on the plurality of reference blocks may include fusing, by the processor, the plurality of filtered reference blocks to obtain a fused plurality of filtered reference blocks. In some implementations, in response to determining the FInter prediction mode is selected for a current block, the generating, by the processor, the FInter prediction of the current block based on the plurality of reference blocks may include generating, by the processor, an FInter prediction of the current block based on the fused plurality of filtered reference blocks.

In some implementations, the method may include parsing, by the processor, a bitstream to obtain a first flag. In some implementations, the method may include, in response to the first flag indicating an FInter prediction mode is enabled for the current block, parsing, by the processor, the bitstream to obtain a second flag. In some implementations, the method may include determining, by the processor, whether FInter prediction mode is selected for the current block based on the second flag.

In some implementations, the first flag may be signaled at an SPS level, a PH level, a PPS level, or an SH level.

In some implementations, the method may include, in response to the determining the FInter prediction mode is not selected for the current block, generating, by the processor, a regular inter prediction of the current block based on the plurality of reference blocks.

In some implementations, the method may include parsing, by the processor, a bitstream to obtain a flag. In some implementations, the method may include determining, by the processor, whether FInter prediction mode is selected for all inter prediction blocks based on the flag.

In some implementations, the obtaining, by a processor, the plurality of reference blocks may include parsing, by the processor, a bitstream to obtain a plurality of motion data. In some implementations, the obtaining, by a processor, the plurality of reference blocks may include generating, by the processor, the plurality of reference blocks based on the plurality of motion data.

In some implementations, in response to determining the FInter prediction mode is selected for a current block, the generating, by the processor, the FInter prediction of the current block based on the plurality of reference blocks may include fusing, by the processor, the plurality of reference blocks to obtain a fused plurality of reference blocks. In some implementations, in response to determining the FInter prediction mode is selected for a current block, the generating, by the processor, the FInter prediction of the current block based on the plurality of reference blocks may include filtering, by the processor, the fused plurality of reference blocks to obtain a fused plurality of filtered reference blocks. In some implementations, in response to determining the FInter prediction mode is selected for a current block, the generating, by the processor, the FInter prediction of the current block based on the plurality of reference blocks may include generating, by the processor, an FInter prediction of the current block based on the fused plurality of filtered reference blocks.

In some implementations, the method may include selecting, by the processor, a set of filter weights for an FInter prediction filter that minimize an MSE between a reference template associated with a reference block and a current template associated with the current block. In some implementations, the method may include generating, by the processor, the FInter prediction filter based on the set of filter weights. In some implementations, the FInter prediction of the current block may be further generated based on the FInter prediction filter.

According to another aspect of the present disclosure, a decoder is provided. The decoder may include a processor and memory storing instructions. The memory storing instructions, which when executed by the processor, may cause the processor to obtain a plurality of reference blocks. The memory storing instructions, which when executed by the processor, may cause the processor to, in response to determining an FInter prediction mode is selected for a current block, generate an FInter prediction of the current block based on the plurality of reference blocks.

In some implementations, in response to determining an FInter prediction mode is selected for a current block, to generate the FInter prediction of the current block based on the plurality of reference blocks, the memory storing instructions, which when executed by the processor, may cause the processor to filter each of the plurality of reference blocks separately using a corresponding filter to obtain a plurality of filtered reference blocks. In some implementations, in response to determining an FInter prediction mode is selected for a current block, to generate the FInter prediction of the current block based on the plurality of reference blocks, the memory storing instructions, which when executed by the processor, may cause the processor to fuse the plurality of filtered reference blocks to obtain a fused plurality of filtered reference blocks. In some implementations, in response to determining an FInter prediction mode is selected for a current block, to generate the FInter prediction of the current block based on the plurality of reference blocks, the memory storing instructions, which when executed by the processor, may cause the processor to generate an FInter prediction of the current block based on the fused plurality of filtered reference blocks.

In some implementations, the memory storing instructions, which when executed by the processor, may cause the processor to parse a bitstream to obtain a first flag. In some implementations, the memory storing instructions, which when executed by the processor, may cause the processor to, in response to the first flag indicating an FInter prediction mode is enabled for the current block, parse the bitstream to obtain a second flag. In some implementations, the memory storing instructions, which when executed by the processor, may cause the processor to determine whether FInter prediction mode is selected for the current block based on the second flag.

In some implementations, the first flag may be signaled at an SPS level, a PH level, a PPS level, or an SH level.

In some implementations, the memory storing instructions, which when executed by the processor, may cause the processor to, in response to the determining the FInter prediction mode is not selected for the current block, generate a regular inter prediction of the current block based on the plurality of reference blocks.

In some implementations, the memory storing instructions, which when executed by the processor, may cause the processor to parse a bitstream to obtain a flag. In some implementations, the memory storing instructions, which when executed by the processor, may cause the processor to determine whether FInter prediction mode is selected for all inter prediction blocks based on the flag.

In some implementations, to obtain the plurality of reference blocks, the memory storing instructions, which when executed by the processor, may cause the processor to parse a bitstream to obtain a plurality of motion data. In some implementations, to obtain the plurality of reference blocks, the memory storing instructions, which when executed by the processor, may cause the processor to generate the plurality of reference blocks based on the plurality of motion data.

In some implementations, in response to determining an FInter prediction mode is selected for a current block, to generate the FInter prediction of the current block based on the plurality of reference blocks, the memory storing instructions, which when executed by the processor, may cause the processor to fuse the plurality of reference blocks to obtain a fused plurality of reference blocks. In some implementations, in response to determining an FInter prediction mode is selected for a current block, to generate the FInter prediction of the current block based on the plurality of reference blocks, the memory storing instructions, which when executed by the processor, may cause the processor to filter the fused plurality of reference blocks to obtain a fused plurality of filtered reference blocks. In some implementations, in response to determining an FInter prediction mode is selected for a current block, to generate the FInter prediction of the current block based on the plurality of reference blocks, the memory storing instructions, which when executed by the processor, may cause the processor to generate an FInter prediction of the current block based on the fused plurality of filtered reference blocks.

In some implementations, the memory storing instructions, which when executed by the processor, may cause the processor to select a set of filter weights for an FInter prediction filter that minimize an MSE between a reference template associated with a reference block and a current template associated with the current block. In some implementations, the memory storing instructions, which when executed by the processor, may cause the processor to generate the FInter prediction filter based on the set of filter weights. In some implementations, the FInter prediction of the current block may be further generated based on the FInter prediction filter.

According to another aspect of the present disclosure, an apparatus for decoding is provided. The apparatus for decoding may include a processor and memory storing instructions. The memory storing instructions, which when executed by the processor, may cause the processor to obtain a plurality of reference blocks. The memory storing instructions, which when executed by the processor, may cause the processor to, in response to determining an FInter prediction mode is selected for a current block, generate an FInter prediction of the current block based on the plurality of reference blocks.

According to still another aspect of the present disclosure, a non-transitory computer-readable medium storing instructions is provided. The instructions, which when executed by the processor of the decoder, may cause the processor of the decoder to obtain a plurality of reference blocks. The instructions, which when executed by the processor of the decoder, may cause the processor of the decoder to, in response to determining an FInter prediction mode is selected for a current block, generate an FInter prediction of the current block based on the plurality of reference blocks.

In some implementations, in response to determining an FInter prediction mode is selected for a current block, to generate the FInter prediction of the current block based on the plurality of reference blocks, the instructions, which when executed by the processor of the decoder, may cause the processor of the decoder to filter each of the plurality of reference blocks separately using a corresponding filter to obtain a plurality of filtered reference blocks. In some implementations, in response to determining an FInter prediction mode is selected for a current block, to generate the FInter prediction of the current block based on the plurality of reference blocks, the instructions, which when executed by the processor of the decoder, may cause the processor of the decoder to fuse the plurality of filtered reference blocks to obtain a fused plurality of filtered reference blocks. In some implementations, in response to determining an FInter prediction mode is selected for a current block, to generate the FInter prediction of the current block based on the plurality of reference blocks, the instructions, which when executed by the processor of the decoder, may cause the processor of the decoder to generate an FInter prediction of the current block based on the fused plurality of filtered reference blocks.

In some implementations, the instructions, which when executed by the processor of the decoder, may cause the processor of the decoder to parse a bitstream to obtain a first flag. In some implementations, the instructions, which when executed by the processor of the decoder, may cause the processor of the decoder to, in response to the first flag indicating an FInter prediction mode is enabled for the current block, parse the bitstream to obtain a second flag. In some implementations, the instructions, which when executed by the processor of the decoder, may cause the processor of the decoder to determine whether FInter prediction mode is selected for the current block based on the second flag.

In some implementations, the first flag may be signaled at an SPS level, a PH level, a PPS level, or an SH level.

In some implementations, the instructions, which when executed by the processor of the decoder, may cause the processor of the decoder to, in response to the determining the FInter prediction mode is not selected for the current block, generate a regular inter prediction of the current block based on the plurality of reference blocks.

In some implementations, the instructions, which when executed by the processor of the decoder, may cause the processor of the decoder to parse a bitstream to obtain a flag. In some implementations, the instructions, which when executed by the processor of the decoder, may cause the processor of the decoder to determine whether FInter prediction mode is selected for all inter prediction blocks based on the flag.

In some implementations, to obtain the plurality of reference blocks, the instructions, which when executed by the processor of the decoder, may cause the processor of the decoder to parse a bitstream to obtain a plurality of motion data. In some implementations, to obtain the plurality of reference blocks, the instructions, which when executed by the processor of the decoder, may cause the processor of the decoder to generate the plurality of reference blocks based on the plurality of motion data.

In some implementations, in response to determining an FInter prediction mode is selected for a current block, to generate the FInter prediction of the current block based on the plurality of reference blocks, the instructions, which when executed by the processor of the decoder, may cause the processor of the decoder to fuse the plurality of reference blocks to obtain a fused plurality of reference blocks. In some implementations, in response to determining an FInter prediction mode is selected for a current block, to generate the FInter prediction of the current block based on the plurality of reference blocks, the instructions, which when executed by the processor of the decoder, may cause the processor of the decoder to filter the fused plurality of reference blocks to obtain a fused plurality of filtered reference blocks. In some implementations, in response to determining an FInter prediction mode is selected for a current block, to generate the FInter prediction of the current block based on the plurality of reference blocks, the instructions, which when executed by the processor of the decoder, may cause the processor of the decoder to generate an FInter prediction of the current block based on the fused plurality of filtered reference blocks.

In some implementations, the instructions, which when executed by the processor of the decoder, may cause the processor of the decoder to select a set of filter weights for an FInter prediction filter that minimize an MSE between a reference template associated with a reference block and a current template associated with the current block. In some implementations, the instructions, which when executed by the processor of the decoder, may cause the processor of the decoder to generate the FInter prediction filter based on the set of filter weights. In some implementations, the FInter prediction of the current block may be further generated based on the FInter prediction filter.

According to one aspect of the present disclosure, a method of encoding is provided. The method may include obtaining, by a processor, a plurality of reference blocks. The method may include, in response to determining an FInter prediction mode is selected for a current block, generating, by the processor, an FInter prediction of the current block based on the plurality of reference blocks.

In some implementations, in response to determining the FInter prediction mode is selected for a current block, the generating, by the processor, the FInter prediction of the current block based on the plurality of reference blocks may include filtering, by the processor, each of the plurality of reference blocks separately using a corresponding filter to obtain a plurality of filtered reference blocks. In some implementations, in response to determining the FInter prediction mode is selected for a current block, the generating, by the processor, the FInter prediction of the current block based on the plurality of reference blocks may include fusing, by the processor, the plurality of filtered reference blocks to obtain a fused plurality of filtered reference blocks. In some implementations, in response to determining the FInter prediction mode is selected for a current block, the generating, by the processor, the FInter prediction of the current block based on the plurality of reference blocks may include generating, by the processor, an FInter prediction of the current block based on the fused plurality of filtered reference blocks.

In some implementations, the method may include encoding, by the processor, a first flag. In some implementations, the method may include, in response to the first flag indicating an FInter prediction mode is enabled for the current block, encoding, by the processor, a second flag. In some implementations, the method may include determining, by the processor, whether FInter prediction mode is selected for the current block based on the second flag.

In some implementations, the first flag may be signaled at an SPS level, a PH level, a PPS level, or an SH level.

In some implementations, the method may include, in response to the determining the FInter prediction mode is not selected for the current block, generating, by the processor, a regular inter prediction of the current block based on the plurality of reference blocks.

In some implementations, the method may include encoding, by the processor, a flag. In some implementations, the method may include determining, by the processor, whether FInter prediction mode is selected for all inter prediction blocks based on the flag.

In some implementations, the obtaining, by a processor, the plurality of reference blocks may include encoding, by the processor, a plurality of motion data. In some implementations, the obtaining, by a processor, the plurality of reference blocks may include generating, by the processor, the plurality of reference blocks based on the plurality of motion data.

In some implementations, in response to determining the FInter prediction mode is selected for a current block, the generating, by the processor, the FInter prediction of the current block based on the plurality of reference blocks may include fusing, by the processor, the plurality of reference blocks to obtain a fused plurality of reference blocks. In some implementations, in response to determining the FInter prediction mode is selected for a current block, the generating, by the processor, the FInter prediction of the current block based on the plurality of reference blocks may include filtering, by the processor, the fused plurality of reference blocks to obtain a fused plurality of filtered reference blocks. In some implementations, in response to determining the FInter prediction mode is selected for a current block, the generating, by the processor, the FInter prediction of the current block based on the plurality of reference blocks may include generating, by the processor, an FInter prediction of the current block based on the fused plurality of filtered reference blocks.

In some implementations, the method may include selecting, by the processor, a set of filter weights for an FInter prediction filter that minimize an MSE between a reference template associated with a reference block and a current template associated with the current block. In some implementations, the method may include generating, by the processor, the FInter prediction filter based on the set of filter weights. In some implementations, the FInter prediction of the current block may be further generated based on the FInter prediction filter.

According to another aspect of the present disclosure, a encoder is provided. The encoder may include a processor and memory storing instructions. The memory storing instructions, which when executed by the processor, may cause the processor to obtain a plurality of reference blocks. The memory storing instructions, which when executed by the processor, may cause the processor to, in response to determining an FInter prediction mode is selected for a current block, generate an FInter prediction of the current block based on the plurality of reference blocks.

In some implementations, in response to determining an FInter prediction mode is selected for a current block, to generate the FInter prediction of the current block based on the plurality of reference blocks, the memory storing instructions, which when executed by the processor, may cause the processor to filter each of the plurality of reference blocks separately using a corresponding filter to obtain a plurality of filtered reference blocks. In some implementations, in response to determining an FInter prediction mode is selected for a current block, to generate the FInter prediction of the current block based on the plurality of reference blocks, the memory storing instructions, which when executed by the processor, may cause the processor to fuse the plurality of filtered reference blocks to obtain a fused plurality of filtered reference blocks. In some implementations, in response to determining an FInter prediction mode is selected for a current block, to generate the FInter prediction of the current block based on the plurality of reference blocks, the memory storing instructions, which when executed by the processor, may cause the processor to generate an FInter prediction of the current block based on the fused plurality of filtered reference blocks.

In some implementations, the memory storing instructions, which when executed by the processor, may cause the processor to encode a first flag. In some implementations, the memory storing instructions, which when executed by the processor, may cause the processor to, in response to the first flag indicating an FInter prediction mode is enabled for the current block, encode a second flag. In some implementations, the memory storing instructions, which when executed by the processor, may cause the processor to determine whether FInter prediction mode is selected for the current block based on the second flag.

In some implementations, the first flag may be signaled at an SPS level, a PH level, a PPS level, or an SH level.

In some implementations, the memory storing instructions, which when executed by the processor, may cause the processor to, in response to the determining the FInter prediction mode is not selected for the current block, generate a regular inter prediction of the current block based on the plurality of reference blocks.

In some implementations, the memory storing instructions, which when executed by the processor, may cause the processor to encode a flag. In some implementations, the memory storing instructions, which when executed by the processor, may cause the processor to determine whether FInter prediction mode is selected for all inter prediction blocks based on the flag.

In some implementations, to obtain the plurality of reference blocks, the memory storing instructions, which when executed by the processor, may cause the processor to encode a plurality of motion data. In some implementations, to obtain the plurality of reference blocks, the memory storing instructions, which when executed by the processor, may cause the processor to generate the plurality of reference blocks based on the plurality of motion data.

In some implementations, in response to determining an FInter prediction mode is selected for a current block, to generate the FInter prediction of the current block based on the plurality of reference blocks, the memory storing instructions, which when executed by the processor, may cause the processor to fuse the plurality of reference blocks to obtain a fused plurality of reference blocks. In some implementations, in response to determining an FInter prediction mode is selected for a current block, to generate the FInter prediction of the current block based on the plurality of reference blocks, the memory storing instructions, which when executed by the processor, may cause the processor to filter the fused plurality of reference blocks to obtain a fused plurality of filtered reference blocks. In some implementations, in response to determining an FInter prediction mode is selected for a current block, to generate the FInter prediction of the current block based on the plurality of reference blocks, the memory storing instructions, which when executed by the processor, may cause the processor to generate an FInter prediction of the current block based on the fused plurality of filtered reference blocks.

In some implementations, the memory storing instructions, which when executed by the processor, may cause the processor to select a set of filter weights for an FInter prediction filter that minimize an MSE between a reference template associated with a reference block and a current template associated with the current block. In some implementations, the memory storing instructions, which when executed by the processor, may cause the processor to generate the FInter prediction filter based on the set of filter weights. In some implementations, the FInter prediction of the current block may be further generated based on the FInter prediction filter.

According to another aspect of the present disclosure, an apparatus for encoding is provided. The apparatus for encoding may include a processor and memory storing instructions. The memory storing instructions, which when executed by the processor, may cause the processor to obtain a plurality of reference blocks. The memory storing instructions, which when executed by the processor, may cause the processor to, in response to determining an FInter prediction mode is selected for a current block, generate an FInter prediction of the current block based on the plurality of reference blocks.

According to still another aspect of the present disclosure, a non-transitory computer-readable medium storing instructions is provided. The instructions, which when executed by the processor of the encoder, may cause the processor of the encoder to obtain a plurality of reference blocks. The instructions, which when executed by the processor of the encoder, may cause the processor of the encoder to, in response to determining an FInter prediction mode is selected for a current block, generate an FInter prediction of the current block based on the plurality of reference blocks.

In some implementations, in response to determining an FInter prediction mode is selected for a current block, to generate the FInter prediction of the current block based on the plurality of reference blocks, the instructions, which when executed by the processor of the encoder, may cause the processor of the encoder to filter each of the plurality of reference blocks separately using a corresponding filter to obtain a plurality of filtered reference blocks. In some implementations, in response to determining an FInter prediction mode is selected for a current block, to generate the FInter prediction of the current block based on the plurality of reference blocks, the instructions, which when executed by the processor of the encoder, may cause the processor of the encoder to fuse the plurality of filtered reference blocks to obtain a fused plurality of filtered reference blocks. In some implementations, in response to determining an FInter prediction mode is selected for a current block, to generate the FInter prediction of the current block based on the plurality of reference blocks, the instructions, which when executed by the processor of the encoder, may cause the processor of the encoder to generate an FInter prediction of the current block based on the fused plurality of filtered reference blocks.

In some implementations, the instructions, which when executed by the processor of the encoder, may cause the processor of the encoder to encode a first flag. In some implementations, the instructions, which when executed by the processor of the encoder, may cause the processor of the encoder to, in response to the first flag indicating an FInter prediction mode is enabled for the current block, encode a second flag. In some implementations, the instructions, which when executed by the processor of the encoder, may cause the processor of the encoder to determine whether FInter prediction mode is selected for the current block based on the second flag.

In some implementations, the first flag may be signaled at an SPS level, a PH level, a PPS level, or an SH level.

In some implementations, the instructions, which when executed by the processor of the encoder, may cause the processor of the encoder to, in response to the determining the FInter prediction mode is not selected for the current block, generate a regular inter prediction of the current block based on the plurality of reference blocks.

In some implementations, the instructions, which when executed by the processor of the encoder, may cause the processor of the encoder to encode a flag. In some implementations, the instructions, which when executed by the processor of the encoder, may cause the processor of the encoder to determine whether FInter prediction mode is selected for all inter prediction blocks based on the flag.

In some implementations, to obtain the plurality of reference blocks, the instructions, which when executed by the processor of the encoder, may cause the processor of the encoder to encode a plurality of motion data. In some implementations, to obtain the plurality of reference blocks, the instructions, which when executed by the processor of the encoder, may cause the processor of the encoder to generate the plurality of reference blocks based on the plurality of motion data.

In some implementations, in response to determining an FInter prediction mode is selected for a current block, to generate the FInter prediction of the current block based on the plurality of reference blocks, the instructions, which when executed by the processor of the encoder, may cause the processor of the encoder to fuse the plurality of reference blocks to obtain a fused plurality of reference blocks. In some implementations, in response to determining an FInter prediction mode is selected for a current block, to generate the FInter prediction of the current block based on the plurality of reference blocks, the instructions, which when executed by the processor of the encoder, may cause the processor of the encoder to filter the fused plurality of reference blocks to obtain a fused plurality of filtered reference blocks. In some implementations, in response to determining an FInter prediction mode is selected for a current block, to generate the FInter prediction of the current block based on the plurality of reference blocks, the instructions, which when executed by the processor of the encoder, may cause the processor of the encoder to generate an FInter prediction of the current block based on the fused plurality of filtered reference blocks.

In some implementations, the instructions, which when executed by the processor of the encoder, may cause the processor of the encoder to select a set of filter weights for an FInter prediction filter that minimize an MSE between a reference template associated with a reference block and a current template associated with the current block. In some implementations, the instructions, which when executed by the processor of the encoder, may cause the processor of the encoder to generate the FInter prediction filter based on the set of filter weights. In some implementations, the FInter prediction of the current block may be further generated based on the FInter prediction filter.

According to still a further aspect of the present disclosure, a non-transitory computer-readable medium storing a bitstream is provided. The bitstream may be generated according to one or more of the operations disclosed herein.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method for decoding, performed by a decoder comprising a processor, the method comprising:
obtaining, by the processor, a plurality of reference blocks; and
in response to determining a filter inter (FInter) prediction mode is selected for a current block, generating, by the processor, an FInter prediction of the current block based on the plurality of reference blocks.

2. The method of claim 1, wherein, in response to determining the FInter prediction mode is selected for the current block, the generating, by the processor, the FInter prediction of the current block based on the plurality of reference blocks comprises:
filtering, by the processor, each of the plurality of reference blocks separately using a corresponding filter to obtain a plurality of filtered reference blocks;
fusing, by the processor, the plurality of filtered reference blocks to obtain a fused plurality of filtered reference blocks; and
generating, by the processor, the FInter prediction of the current block based on the fused plurality of filtered reference blocks.

3. The method of claim 1, further comprising:
parsing, by the processor, a bitstream to obtain a first flag;
in response to the first flag indicating an FInter prediction mode is enabled for the current block, parsing, by the processor, the bitstream to obtain a second flag; and
determining, by the processor, whether FInter prediction mode is selected for the current block based on the second flag.

4. The method of claim 3, wherein the first flag is signaled at a sequence parameter set (SPS) level, a picture header (PH) level, a picture parameter set (PPS) level, or a slice header (SH) level.

5. The method of claim 3, further comprising:
in response to the determining the FInter prediction mode is not selected for the current block, generating, by the processor, a regular inter prediction of the current block based on the plurality of reference blocks.

6. The method of claim 1, further comprising:
parsing, by the processor, a bitstream to obtain a flag; and
determining, by the processor, whether FInter prediction mode is selected for all inter prediction blocks based on the flag.

7. The method of claim 1, wherein the obtaining, by the processor, the plurality of reference blocks comprises:
parsing, by the processor, a bitstream to obtain a plurality of motion data; and
generating, by the processor, the plurality of reference blocks based on the plurality of motion data.

8. The method of claim 1, wherein, in response to determining the FInter prediction mode is selected for the current block, the generating, by the processor, the FInter prediction of the current block based on the plurality of reference blocks comprises:
fusing, by the processor, the plurality of reference blocks to obtain a fused plurality of reference blocks;
filtering, by the processor, the fused plurality of reference blocks to obtain a fused plurality of filtered reference blocks; and
generating, by the processor, the FInter prediction of the current block based on the fused plurality of filtered reference blocks.

9. The method of claim 1, further comprising:
selecting, by the processor, a set of filter weights for an FInter prediction filter that minimize a mean-square error (MSE) between a reference template associated with a reference block and a current template associated with the current block; and
generating, by the processor, the FInter prediction filter based on the set of filter weights, wherein the FInter prediction of the current block is further generated based on the FInter prediction filter.

10. A decoder, comprising:
a processor; and
memory storing instructions, which when executed by the processor, cause the processor to:
obtain a plurality of reference blocks; and
in response to determining a filter inter (FInter) prediction mode is selected for a current block, generate an FInter prediction of the current block based on the plurality of reference blocks.

11. A method for encoding, performed by an encoder comprising a processor, the method comprising:
obtaining, by the processor, a plurality of reference blocks; and
in response to determining a filter inter (FInter) prediction mode is selected for a current block, generating, by the processor, an FInter prediction of the current block based on the plurality of reference blocks.

12. The method of claim 11, wherein, in response to determining the FInter prediction mode is selected for the current block, the generating, by the processor, the FInter prediction of the current block based on the plurality of reference blocks comprises:
filtering, by the processor, each of the plurality of reference blocks separately using a corresponding filter to obtain a plurality of filtered reference blocks;
fusing, by the processor, the plurality of filtered reference blocks to obtain a fused plurality of filtered reference blocks; and
generating, by the processor, the FInter prediction of the current block based on the fused plurality of filtered reference blocks.

13. The method of claim 11, further comprising:
encoding, by the processor, a first flag;
in response to the first flag indicating an FInter prediction mode is enabled for the current block, encoding, by the processor, a second flag; and
determining, by the processor, whether FInter prediction mode is selected for the current block based on the second flag.

14. The method of claim 13, wherein the first flag is signaled at a sequence parameter set (SPS) level, a picture header (PH) level, a picture parameter set (PPS) level, or a slice header (SH) level.

15. The method of claim 13, further comprising:
in response to the determining the FInter prediction mode is not selected for the current block, generating, by the processor, a regular inter prediction of the current block based on the plurality of reference blocks.

16. The method of claim 11, further comprising:
encoding, by the processor, a flag; and
determining, by the processor, whether FInter prediction mode is selected for all inter prediction blocks based on the flag.

17. The method of claim 11, wherein the obtaining, by the processor, the plurality of reference blocks comprises:
encoding, by the processor, a plurality of motion data; and
generating, by the processor, the plurality of reference blocks based on the plurality of motion data.

18. The method of claim 11, wherein, in response to determining the FInter prediction mode is selected for the current block, the generating, by the processor, the FInter prediction of the current block based on the plurality of reference blocks comprises:
fusing, by the processor, the plurality of reference blocks to obtain a fused plurality of reference blocks;
filtering, by the processor, the fused plurality of reference blocks to obtain a fused plurality of filtered reference blocks; and
generating, by the processor, the FInter prediction of the current block based on the fused plurality of filtered reference blocks.

19. The method of claim 11, further comprising:
selecting, by the processor, a set of filter weights for an FInter prediction filter that minimize a mean-square error (MSE) between a reference template associated with a reference block and a current template associated with the current block; and
generating, by the processor, the FInter prediction filter based on the set of filter weights, wherein the FInter prediction of the current block is further generated based on the FInter prediction filter.

20. A computer-readable storage medium, having a computer program and a bitstream stored thereon, wherein the computer program, when executed by a processor, enables the processor to perform the encoding method of claim 11 to generate the bitstream.
